(19) United States
(12) Patent Application Publication
(10) Pub. No.: US 2026/0350112 A1
(43) Pub. Date: Nov. 5, 2026

(54) Using First-Order Theories of Boolean Algebras to Provide Safe AI Systems and a Novel Software Specification Logic

(71) Applicant: IDNI AG, Triesen (LI)

(72) Inventor: Ohad Asor, Triesen (LI)

(21) Appl. No.: 19/738,432

(22) Filed: Jul. 12, 2026

Related U.S. Application Data
(63) Continuation-in-part of application No. 19/083,375, filed on Mar. 18, 2025.
(63) Continuation of application No. PCT/IB2025/000020, filed on Jan. 17, 2025.
Application No. PCT/IB2025/000020 is a continuation-in-part of application No. 18/776,245, filed on Jul. 17, 2024, now Pat. No. 12,254,082.
(60) Provisional application No. 63/564,501, filed on Mar. 12, 2024.
(60) Provisional application No. 63/666,656, filed on Jul. 1, 2024.
(60) Provisional application No. 63/667,692, filed on Jul. 3, 2024.
(60) Provisional application No. 63/726,231, filed on Nov. 27, 2024.

(30) Foreign Application Priority Data
Jan. 17, 2024 (EP) 24152499.0

(51) Int. Cl. G06F 17/11

(52) U.S. Cl. CPC G06F 17/11

(57) ABSTRACT

A method validating commands for a software platform. The platform receives user input to specify a command for the software platform to perform an action. The command is expressed in an extended formal language comprising elements in a Boolean Algebra. The platform retrieving validation rules for the software platform. The validation rules are expressed in the extended formal language. The platform combines the command and the validation rules to build a formula in the extended formal language, including one or more logical quantifiers. The platform expresses the formula in disjunctive normal form, with an existential innermost quantifier and constructs a new formula in the extended formal language that is logically equivalent to the formula and has no quantifiers. The platform evaluates the truth of the new formula and executes the command to perform the action when the new formula is true. Otherwise, the platform rejects the command.

### RELATED APPLICATIONS

This application is a continuation of International Application PCT/IB2025/000020 filed Jan. 17, 2025, titled “Using First-Order Theories of Boolean Algebras to Provide Safe AI Systems and a Novel Software Specification Logic,” which is a continuation-in-part application of U.S. patent application Ser. No. 18/776,245, filed Jul. 17, 2024, titled “Using First-Order Theories of Boolean Algebras to Provide Safe AI Systems and a Novel Software Specification Logic,” which claims priority to European Application No. 24152499.0, filed Jan. 17, 2024, titled “Validation of Computer Software Updates,” each of which is incorporated by reference herein in its entirety.

This application is a continuation-in-part of U.S. patent application Ser. No. 19/083,375 filed Mar. 18, 2025, titled “Using First-Order Theories of Boolean Algebras to Provide Safe AI Systems and a Novel Software Specification Logic,” which is incorporated by reference herein in its entirety.

International Application PCT/IB2025/000020 claims priority to U.S. Provisional Application Ser. No. 63/564,501, filed Mar. 12, 2024, titled “Applications of Boolean Algebras,” which is incorporated by reference herein in its entirety.

International Application PCT/IB2025/000020 claims priority to U.S. Provisional Application Ser. No. 63/666,656, filed Jul. 1, 2024, titled “Utilizing a Novel Temporal Logic with Guarded Successor,” which is incorporated by reference herein in its entirety.

International Application PCT/IB2025/000020 claims priority to U.S. Provisional Application Ser. No. 63/667,692, filed Jul. 3, 2024, titled “Utilizing a Novel Temporal Logic with Guarded Successor,” which is incorporated by reference herein in its entirety.

International Application PCT/IB2025/000020 claims priority to U.S. Provisional Application Ser. No. 63/726,231, filed Nov. 27, 2024, titled “Using First-Order Theories of Boolean Algebras to Provide Safe AI Systems and a Novel Software Specification Logic,” which is incorporated by reference herein in its entirety.

### TECHNICAL FIELD

The present invention relates to formal languages, and more specifically to the use of Boolean Algebras in the context of formal languages.

### BACKGROUND

Designing formal or logical languages with the ability to refer to the truth of their own sentences has been historically problematic in the field of logic. Generally speaking, it is not possible to include statements about truth in a formal language—and about statements in the same language—while keeping the language consistent. This is because the inclusion of such truth reference allows languages to express paradoxes. Perhaps the most widely known result of this nature is Tarski's so-called Undefinability of Truth theorem (Tarski's undefinability theorem—Wikipedia).

This inability to refer to truth in the same formal language is a practical limitation in computing. In particular, one formal language cannot refer to whether another statement in that language is true, or whether one sentence entails the other, as well as similar logical questions that come down to speaking about truth. Known approaches for addressing this issue include so-called paraconsistent and many-valued logics; however, all of the known approaches are of the nature of allowing the languages to contain paradoxes. In this way, the languages are rendered to be so-called nonclassical logics. In those languages, it is therefore no longer the case that every precise statement is either true or false (in a given model if such a setting even has a model theory) in the classical sense.

In computing, the above issue is problematic for performing automatic updates to a computer software system installed on a computing device, and more generally, for the case where a system implemented in a certain language is able to deal with sentences in the same language (where performing a software update is one example of such a situation). In one example, an auto-update feature may download a software update, check that the software update satisfies one or more conditions, and then install the software update only if the one or more conditions are satisfied. As checking the condition is of the form of a logical implication (i.e. ‘does the update entail that certain conditions are met?’), then there is currently no formal language that can support implementation of such an auto-update feature while expressing the current software and the software update in the same formal language, as such a language would include a contradiction. Also from a computational implementation point of view, having two languages is unhelpful: either the update-condition itself cannot be updated, or one would need unboundedly many different languages, one per update, entailing even more difficulties.

Also in computing, the above-outlined issue relating to paradoxes in formal languages is relevant to the computational implementation of knowledge representation and reasoning systems (KRRs) or, simply, knowledge systems. KRR is a sub-field of artificial intelligence that focuses on how to represent and manipulate knowledge in a way that allows computers to reason, infer, and make decisions based on that knowledge. KRR has applications in various domains, including expert systems, decision support systems, robotics, semantic web, and more. Common formalisms and languages used in KRR include first-order logic, description logics, semantic networks, and rule-based systems. Once knowledge is represented, KRR systems use various inference mechanisms to derive new information or conclusions from the existing knowledge. These mechanisms include deductive reasoning (using logical rules), inductive reasoning (generalizing from specific examples) and probabilistic reasoning (considering uncertainty and probabilities). Inference engines are the software components responsible for implementing in software these inference mechanisms taking as input the formal knowledge representations, namely, sentences in some formal or logical language(s). In particular, it is desired for these inference engines to be able to determine whether a statement that can be expressed in any given knowledge representation language, is a contradictory statement. Many logical reasoning tasks may be reduced to contradiction detection. For example, to determine whether sentence X entails sentence Y, it is asked whether the sentence “X and not Y” is contradictory. In a case where Y contains free variables, finding all assignments that make the above entailment true amounts to query answering. The abovementioned KRR languages deal with objects and relations between objects. It is of practical necessity to also deal with objects being sentences in the language itself. For example, in “X said Y”, Y is also a sentence. However, no known KRR language (or logic in general) can consistently handle statements in its own language, combining them with other sentences, and referring to whether they contain a contradiction, or entail each other, and so on for other logical questions.

It is against this background to which the present invention is set.

### SUMMARY

In an aspect of the present invention there is provided a computer-implemented method of validating software updates. The method is performed by a software system or software platform implemented or installed on a computing device having one or more processors and a memory device storing instructions thereon that, when executed by the one or more processors, cause the one or more processors to perform the method described herein.

The method, performed by the software system, comprises receiving a candidate software update for the software system. Both the software system and the candidate software update are expressed in an extended formal language that is an extension of one or more base formal languages. Sentences in each base formal language, up to logical equivalence, form elements in a Boolean Algebra, that has a falsity element 0 denoting falsity and that has a truth element 1 denoting truth. The extended formal language includes the many-sorted first-order theory of Boolean Algebras interpreted in the Boolean Algebra arising from each base formal language, extended to include a plurality of constant symbols each corresponding to a respective logical equivalence class of sentences in each base formal language. The extended formal language and each base formal language, regarded as Boolean Algebras under logical equivalence, are elementarily equivalent under a signature of Boolean Algebra. The candidate software update corresponds to an update sentence u in the extended formal language.

For a condition element c, in the extended formal language, specifying a condition to validate the candidate software update, the method, performed by the software system, comprises computing a truth value for uc′=0 in the extended formal language. Here, uc′ is the logical conjunction of u with the logical negation of c. The condition may be regarded as being implied from the software system as a whole. In particular, the condition element c may be recited explicitly in the extended formal language, or it may be implied from the extended formal language describing the software system. The condition may be any suitable condition, e.g. if the new code in the candidate software update implies that private data is sent over a (public) network then the update should be rejected. However, note that the specific content/requirements of the condition is not of relevance to the inventive concept disclosed herein.

In accordance with a determination that uc′=0 is false, the method comprises rejecting the candidate software update. In accordance with a determination that uc′=0 is true, the method comprises accepting the candidate software update, and installing the candidate software update on the computing device. That is, the candidate software update is the updated software of the software system, i.e. the software system determines whether to update itself with the candidate software update.

This aspect of the invention is advantageous in that the software system can autonomously accept or reject updates according to certain conditions, including, updating those very conditions themselves. Existing formal languages would not permit such an update. These advantages are achieved by virtue of the fact that both the software system and the software update (as well as further, subsequent updates) are expressed in the same formal language and that said formal language is classical, and consistent and decidable, even though it refers to its own sentences and their logical relations, what might suspect as impossible due to above Tarski's result. Specifically, this is achievable in the disclosed method by virtue of the fact that sentences in the base logic (base formal language) are abstracted to be seen merely as Boolean algebra elements (or slightly beyond). Here and throughout, the defined extended formal language benefits from being consistent and decidable.

The disclosed method extends to a consideration of a plurality of base formal languages, as defined above.

As is known in the art, in logic and computer science, a formal language is a language with mathematically precise construction rules, such as a programming language. Logic can be considered a formal language in the sense that it provides a framework for expressing and reasoning about propositions and their relationships. In (mathematical) logic, a sentence (or closed formula) is a predicate logic well-formed formula with no free variables. Herein, a sentence is regarded as expressing a set of models in which the sentence holds. It is important to note that we regard Boolean algebras in their full generality, and not only the algebra of binary values.

“Logical equivalence” is a well-defined term in this context. As will be understood by a skilled person, two statements are logically equivalent if they have the same truth value in every model. In model theory, a structure consists of a set along with a collection of functions and relations that are defined on it. “Logical equivalence class” will be similarly well understood by a skilled person (see, e.g., “Equivalence class” on Wikipedia).

It will be understood from the above context that elements of a Boolean Algebra herein are logical sentences up to logical equivalence. This is commonly referred to as Lindenbaum-Tarski Algebra.

References to the first order theory of Boolean Algebra, and to Boolean Algebras that are elementarily equivalent, will be well understood by a skilled person (see, e.g., “List of first-order theories” on Wikipedia). References to many-sorted logic will also be understood (see, e.g., “Many-sorted logic” on Wikipedia). Furthermore, references to a signature of Boolean Algebra will be similarly well understood by a skilled person (see, e.g., “Signature (logic)” on Wikipedia).

The Boolean Algebra of each base formal language may be atomless.

The Boolean Algebras of the extended formal language and each base formal language may be isomorphic or at least elementarily equivalent.

The condition specified by the condition element c may be a combination of different individual conditions each requiring to be satisfied for the candidate software update to be validated and accepted.

The candidate software update may include an update to the condition element c.

If the candidate software update is accepted, then the step of installing the candidate software update on the computing device may include replacing the condition element c with an updated condition element d, in the extended formal language, specifying an updated condition to validate a subsequent candidate software update. (The replacement of the condition c with the condition d is part of the candidate software update.) The updated condition element d may be recited explicitly in the extended formal language, or it may be implied from the extended formal language describing the updated software system.

The method may comprise receiving the subsequent candidate software update for the software system, wherein the subsequent candidate software update is expressed in the extended formal language. Here, the software system may have been updated with the candidate software update. In this way, the software system may be regarded as the updated software system. The method may comprise computing a truth value for ud′=0 in the extended formal language, wherein ud′ is the logical conjunction of u with the logical negation of d. In accordance with a determination that ud′=0 is false, the method may comprise rejecting the subsequent candidate software update. In accordance with a determination that ud′=0 is true, the method may comprise accepting the subsequent candidate software update, and may comprise installing the subsequent candidate software update on the computing device.

In some examples, if uc′=0 is false, then the method may comprise identifying a modified software update, that is a modification of the candidate software update. The modified software update may correspond to a logically maximal sentence v, that logically entails the update sentence u, and that satisfies vc′=0, wherein vc′ is the logical conjunction of v with the logical negation of c. In such examples, the method may comprise accepting the modified software update, and installing the modified software update on the computing device. In some examples, the modified software update may be accepted only if there is a unique logically maximal sentence that logically entails the update sentence u.

In some examples, prior to the step of computing the truth value for uc′=0 in the extended formal language, the method may comprise modifying the candidate software update to obtain a further candidate software update corresponding to a further update sentence w in the extended formal language. The further update sentence w may be obtained based on a formula in the extended formal language that relates the update sentence u to the further update sentence w. For instance, a modification defined by the software system may be applied to the received candidate software update (e.g., to preserve user preferences or settings as part of an update). In accordance with a determination that wc′=0 is false, the method may comprise rejecting the further candidate software update. In accordance with a determination that wc′=0 is true, the method may comprise accepting the further candidate software update, and installing the further candidate software update on the computing device. In such an example in which the received candidate software update is modified prior to evaluation, the steps involving an evaluation of the received candidate software update (e.g., uc′=0) may be suppressed or may not be performed.

In another aspect of the present invention there is provided a computer software system for validating software updates to the software system. The software system is implemented or installed on a computing device having one or more processors and memory storing one or more programs configured for execution by the one or more processors. The software system is configured to receive a candidate software update for the software system. Both the software system and the candidate software update are expressed in an extended formal language that is an extension of one or more base formal languages. Sentences in each base formal language, up to logical equivalence, form elements in a Boolean Algebra, that has a falsity element 0 denoting falsity and that has a truth element 1 denoting truth. The extended formal language includes the many-sorted first-order theory of Boolean Algebras interpreted in the Boolean Algebra arising from each base formal language, extended to include a plurality of constant symbols each corresponding to a respective logical equivalence class of sentences in each base formal language. The extended formal language and each base formal language, regarded as Boolean Algebras under logical equivalence, are elementarily equivalent under a signature of Boolean Algebra. The candidate software update corresponds to an update sentence u in the extended formal language.

For a condition element c, in the extended formal language, specifying a condition to validate the candidate software update, the software system is configured to compute a truth value for uc′=0 in the extended formal language. Here, uc′ is the logical conjunction of u with the logical negation of c.

In accordance with a determination that uc′=0 is false, the software system is configured to reject the candidate software update. In accordance with a determination that uc′=0 is true, the software system is configured to accept the candidate software update, and configured to install the candidate software update on the computing device in order to update the software system.

The condition for update can be more general than uc′=0. In particular, the condition can be any formula in the extended language relating u and c.

In some instances where the condition for update is more general than uc′=0, the condition is expressed as a disjunction of systems of conditions (or any other logically equivalent form), each of the form:

uc[1]=0, . . . ,uc[n]=0

u′d[1]=0, . . . ,u′d[k]=0

up[1]!=0, . . . ,up[i]!=0

u′q[1]!=0, . . . ,u′q[j]!=0

or equivalent, whether or not c, d, p, and q are single elements or whole formulas, and where the whole condition may or may not contain quantifiers.

One example of a practical knowledge system, or knowledge representation and reasoning system, is a software system that is a function of inputs to outputs at each point over time. In such an example, there are an infinite number of inputs and outputs. A database of all “runs” will all be infinite sequences of inputs and corresponding infinite sequences of outputs. This “infinite” database is not possible to implement computationally (in its entirety) with previous representations of the inputs, outputs, function, and so on. Therefore, it is not possible to analyze and reason over the entire knowledge system. The present invention provides an approach that allows for implementation of the knowledge system on a computer such that it may be determined whether any particular “run” (e.g. a combination of input and output) out of all possible runs, causes a problem. For instance, in an example in which the knowledge system describes a nuclear reactor, is there a run that leads to a serious safety breach of the nuclear reactor.

In accordance with another aspect of the invention there is provided a method of extending a knowledge system to allow or support storing and reasoning over sentences in a same language that the knowledge system supports, the method being performed at a computing device having one or more processors and a memory storing the knowledge system, wherein knowledge in the knowledge system is encoded as sentences in a base formal language. The method comprises storing a plurality of interrelated facts, encoded as knowledge sentences in a base formal language, in the knowledge system, and extending the knowledge sentences to be expressed in an extended formal language that is an extension of the base formal language, wherein sentences in the base formal language, up to logical equivalence, form elements in a Boolean Algebra, that has a falsity element 0 denoting falsity and that has a truth element 1 denoting truth, wherein the extended formal language includes the first-order theory of Boolean Algebras interpreted in the Boolean Algebra arising from the base formal language, extended to include a plurality of constant symbols each corresponding to a respective logical equivalence class of sentences in the extended formal language, wherein the extended formal language and the base formal language, regarded as Boolean Algebras under logical equivalence, are elementarily equivalent under a signature of Boolean Algebra. The method comprises executing one or more queries over the knowledge system in the extended formal language. In some embodiments, the queries are performed using one or more Boolean Algebra methods as described herein. In some embodiments, the method comprises determining outputs to logical questions (e.g., consistency and entailment) related to the knowledge system, in the extended formal language.

In accordance with another aspect of the invention there is provided a method of validating contract provisions, performed at a computing device having one or more processors and memory storing one or more programs configured for execution by the one or more processors.

The method comprises receiving a contract, specified as a plurality of clauses represented by respective clause sentences. The clause sentences are expressed in an extended formal language that is an extension of one or more base formal languages. Sentences in each base formal language, up to logical equivalence, form elements in a Boolean Algebra, that has a falsity element 0 denoting falsity and that has a truth element 1 denoting truth. The extended formal language includes the many-sorted first-order theory of Boolean Algebras interpreted in the Boolean Algebra arising from each base formal language, extended to include a plurality of constant symbols each corresponding to a respective logical equivalence class of sentences in each base formal language. The extended formal language and each base formal language, regarded as Boolean Algebras under logical equivalence, are elementarily equivalent under a signature of Boolean Algebra.

For each combination of two or more elements in the extended formal language, where each combination comprises elements representing respective clause sentences representing respective clauses of the plurality of clauses in the contract, the method comprises evaluating whether an expression corresponding to the logical conjunction of each of the elements in the combination equals 0. For instance, if the combination comprises two elements, namely, a first element x representing a respective first clause sentence representing a first clause of the plurality of clauses in the contract and a second element y representing a respective second clause sentence representing a respective second clause of the plurality of clauses in the contract, then the expression would be xy=0, wherein xy is the logical conjunction of x with the logical conjugation of y. Similarly, if the combination comprises three elements, namely, the first and second elements x, y, and a third element z representing a respective third clause sentence representing a respective third clause of the plurality of clauses in the contract, then the expression would be xyz=0.

In accordance with a determination that there exists a combination of elements satisfying the expression, the method comprises determining that the contract has inconsistent provisions. In accordance with a determination that there is no combination of elements satisfying the expression, the method comprises determining that the contract has consistent provisions.

In accordance with another aspect of the invention there is provided a method of validating commands for an interactive software platform, performed at a computing device having one or more processors and memory storing one or more programs configured for execution by the one or more processors. This is useful, for example, to provide “Safe AI” because the commands are validated against a set of conditions prior to execution. The method comprises receiving user input, at the software platform, to specify a command for the software platform to perform an action. The method comprises retrieving a plurality of defined validation rules for the software platform, where each validation rule, of the plurality of validation rules, is represented by respective validation sentences. The validation sentences are expressed in an extended formal language that is an extension of a base formal language. Sentences in the base formal language, up to logical equivalence, form elements in a Boolean Algebra, which has a falsity element 0 denoting falsity and that has a truth element 1 denoting truth. The extended formal language includes the first-order theory of Boolean Algebras interpreted in the Boolean Algebra arising from the base formal language, extended to include a plurality of constant symbols, each corresponding to a respective logical equivalence class of sentences in the base formal language. The extended formal language and the base formal language, regarded as Boolean Algebras under logical equivalence, are elementarily equivalent under a signature of Boolean Algebra. The method comprises combining the command and the set of defined validation rules for the software platform to build a formula f in the extended formal language, where the formula has one or more logical quantifiers. The method comprises expressing the formula f in disjunctive normal form, with an existential innermost quantifier. The method comprises constructing a new formula g in the extended formal language, where the new formula g (i) is logically equivalent to the formula f and (ii) has no quantifiers. The method comprises evaluating the truth of the new formula g. In accordance with a determination that the new formula g is true, the method comprises performing the command. In accordance with a determination that the new formula g is false, the method comprises rejecting the command.

The command may include one or more further validation rules for the software platform. The one or more further validation rules may update one or more of the defined validation rules.

If the command is performed, the defined validation rules may be updated in accordance with the further validation rules to provide updated validation rules, in the extended formal language, for the interactive software platform.

In some instances, the method comprises receiving subsequent user input, at the software platform, to specify a subsequent command for the software platform to perform a subsequent action. In some embodiments, the method comprises translating the subsequent command into a formula k in the base formal language, where the formula (i) includes one or more logical quantifiers and (ii) is expressed in disjunctive normal form. In some embodiments, the method comprises constructing a new formula l in the extended formal language, wherein the new formula l (i) is logically equivalent to the formula k and (ii) has no quantifiers. In some embodiments, the method comprises evaluating whether the new formula e is consistent with the plurality of updated validation rules for the software platform. In accordance with a determination that the new formula e is consistent with the plurality of updated validation rules for the software platform, the method may perform the subsequent command. In accordance with a determination that the new formula l is not consistent with the plurality of validation rules for the software platform, the method may include rejecting the subsequent command.

In accordance with another aspect of the invention there is provided a non-transitory, computer-readable storage medium storing instructions thereon. When the instructions are executed by one or more processors, the instructions cause the one or more processors to execute any one or more of the methods described above.

In accordance with another aspect of the invention, there is provided a software system, implemented or installed on a computing device, configured to perform the steps of any one or more of the methods described above.

In a general sense, the present invention relates to methods in the field of formal languages and, in particular, the invention provides approaches for solving certain problems expressed in the language of Boolean Algebras (and some of its extensions). The invention provides an approach for extending formal languages with the ability to refer to their own sentences (including in the extended language), determining the truth value of their Boolean combinations, and quantifying over sentences.

### BRIEF DESCRIPTION OF THE DRAWINGS

Examples of the invention will now be described with reference to the accompanying drawings, in which:

FIG. 1 illustrates using disclosed techniques to validate commands directed to a software platform, in accordance with some embodiments.

FIG. 2 is a block diagram of a computing device, in accordance with some embodiments.

FIG. 3 provides BNF (Backus Naur Form) productions for the basic syntax of an extended NSO language, in accordance with some embodiments.

FIG. 4 illustrates using disclosed techniques to validate software updates to a software system, in accordance with some embodiments.

### DESCRIPTION OF IMPLEMENTATIONS

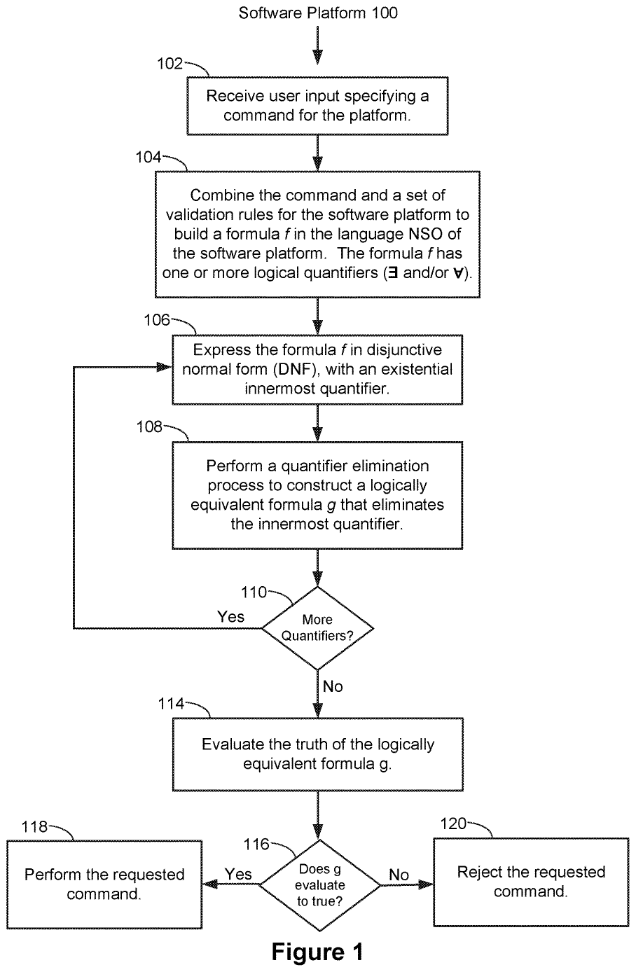

FIG. 1 illustrates using disclosed techniques to validate commands directed to a software platform 100, in accordance with some embodiments. The platform 100 receives (102) a user input specifying a command to perform some action. In some instances, the command directs the platform 100 to perform a tangible and/or visible command, such as display something on a screen, send a message to a recipient, perform a calculation, or initiate a workflow. In other instances, the command directs the platform 100 to update itself, such as adding or modifying a validation rule 242.

The platform 100 combines (104) the command and a set of validation rules for the software platform to build a formula fin the language NSO of the software platform. The formula f includes (104) one or more logical quantifiers (∃ or ∀).

The platform 100 then expresses (106) the formula f in disjunctive normal form (DNF) with an existential innermost quantifier. In some embodiments, this is achieved by converting the formula to either Prenex Normal Form (PNF, consisting of a prefix and a matrix) or to negated PNF, such that the innermost quantifier is existential, then converting the matrix to DNF. In some embodiments, the process identifies the innermost quantifier. If the innermost quantifier is universal, convert it to an existential quantifier by simple negation. Finally, convert everything under the existential quantifier to DNF.

The system then performs (108) a quantifier elimination process to construct a logically equivalent formula g that eliminates the innermost quantifier. This is described below in sections 5 and 6. For example, when the language NSO is an atomless Boolean Algebra, the techniques of section 5 can be applied. This process eliminates the innermost quantifier. The process checks (110) whether there are additional quantifiers. If so, the process repeats steps 106 and 108 to eliminate the next quantifier (after elimination of an identifier, the resulting formula is generally no longer in disjunctive normal form).

When all of the quantifiers have been eliminated, it is a simple matter to evaluate (114) the truth of the formula g. If the formula g does (116) evaluate to true, the software platform performs (118) the requested command. If the formula g does (116) not evaluate to true, the software platform rejects (120) the requested command.

Typically, the validation rules are for security or safety. For example, the platform may refuse to perform an action that would be harmful to others. As noted above, performing the command may entail updating the compatibility rules themselves.

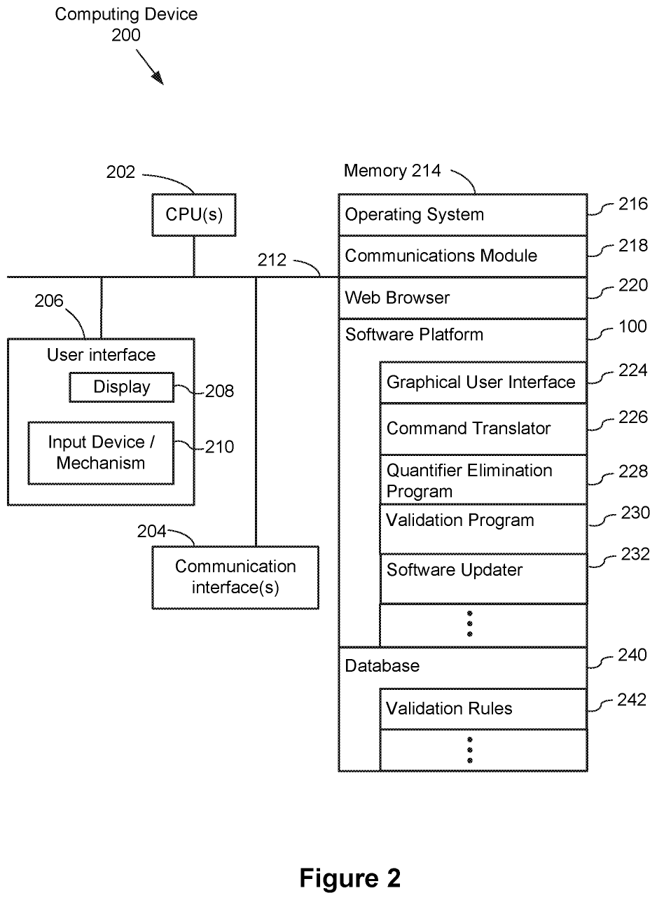

FIG. 2 is a block diagram illustrating a computing device 200 that can run a software platform 100 to validate and perform commands. In some embodiments, the computing device displays a graphical user interface 224 for the software platform 100. Computing devices 200 include desktop computers, laptop computers, tablet computers, and other computing devices with a display and a processor capable of running the software platform 100. A computing device 200 typically includes one or more processing units/cores (CPUs) 202 for executing modules, programs, and/or instructions stored in the memory 214 and thereby performing processing operations; one or more network or other communications interfaces 204; memory 214; and one or more communication buses 212 for interconnecting these components. The communication buses 212 may include circuitry that interconnects and controls communications between system components. A computing device 200 includes a user interface 206 comprising a display 208 and one or more input devices or mechanisms 210. In some implementations, the input device/mechanism includes a keyboard. In some implementations, the input device/mechanism includes a “soft” keyboard, which is displayed as needed on the display 208, enabling a user to “press keys” that appear on the display 208. In some implementations, the display 208 and input device/mechanism 210 comprise a touch screen display (also called a touch sensitive display). In some implementations, the display is an integrated part of the computing device 200. In some implementations, the display is a separate display device.

In some embodiments, the memory 214 includes high-speed random-access memory, such as DRAM, SRAM, DDR RAM or other random-access solid-state memory devices. In some embodiments, the memory 214 includes non-volatile memory, such as one or more magnetic disk storage devices, optical disk storage devices, flash memory devices, or other non-volatile solid-state storage devices. In some embodiments, the memory 214 includes one or more storage devices remotely located from the CPUs 202. The memory 214, or alternatively the non-volatile memory devices within the memory 214, comprises a non-transitory computer-readable storage medium. In some embodiments, the memory 214, or the computer-readable storage medium of the memory 214, stores the following programs, modules, and data structures, or a subset thereof:
an operating system 216, which includes procedures for handling various basic system services and for performing hardware dependent tasks;
a communication module 218, which is used for connecting the computing device 200 to other computers and devices via the one or more communication network interfaces 204 (wired or wireless) and one or more communication networks, such as the Internet, other wide area networks, local area networks, metropolitan area networks, and so on;
a web browser 220 (or other client application), which enables a user to communicate over a network with remote computers or devices;
a software platform 100, which may have a graphical user interface 224 for validating and performing commands. In some embodiments, the software platform includes:
   a command translator 226, which translates a user command into an internal formal language;
   a quantifier elimination program 228, which implements the techniques described in sections 5 and/or 6 below;
   a validation program 230, which validates commands against a set of validation rules 242; and
   a software updater, which updates the software platform when a specified update is consistent with the pre-existing rules; and
One or more databases 240, which store data, such as a set of current validation rules 242.

Each of the above identified executable modules, applications, or set of procedures may be stored in one or more of the previously mentioned memory devices, and corresponds to a set of instructions for performing a function described above. The above identified modules or programs (i.e., sets of instructions) need not be implemented as separate software programs, procedures, or modules, and thus various subsets of these modules may be combined or otherwise re-arranged in various embodiments. In some embodiments, the memory 214 stores a subset of the modules and data structures identified above. In some embodiments, the memory 214 stores additional modules or data structures not described above.

Although FIG. 2 shows a computing device 200, FIG. 2 is intended more as functional description of the various features that may be present rather than as a structural schematic of the embodiments described herein. In practice, and as recognized by those of ordinary skill in the art, items shown separately could be combined and some items could be separated.

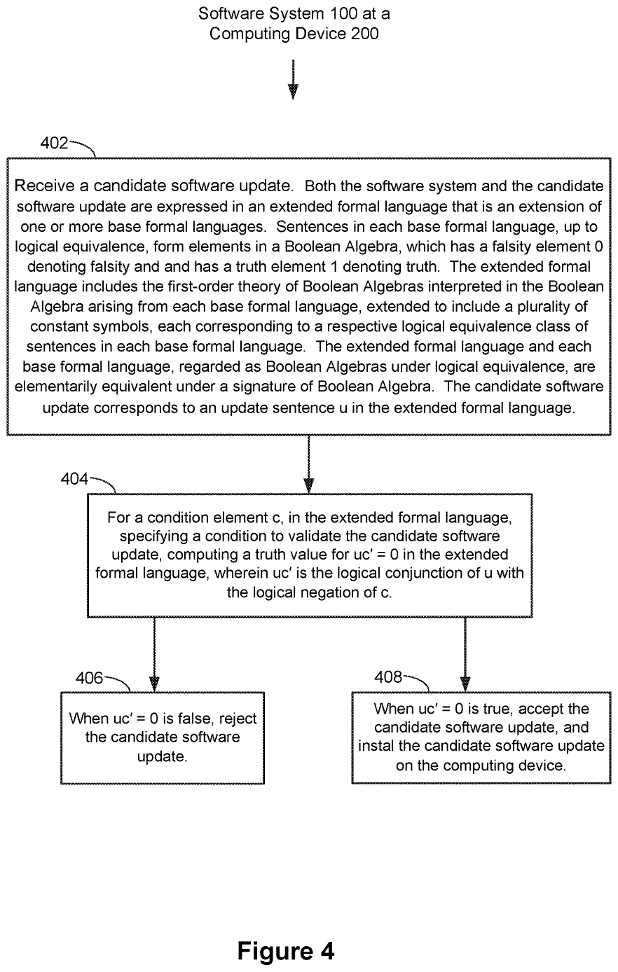

FIG. 4 illustrates using disclosed techniques to validate software updates to a software system, in accordance with some embodiments. The method is performed for a software system 100 running on a computing device 200. The software system 100 receives (402) a candidate update, computes (404) a truth value for a specific formula that includes the update, and either rejects (406) or accepts (408) the update based on the computed truth.

In accordance with some embodiments, a method validates software updates as part of an automatic update feature of a software system 100. The method is performed by the software system 100 installed on the computing device 200. FIG. 4 summarizes the steps of the method. A first step 402 of the method involves receiving or downloading a “candidate” software update for the software system 100. Here, both the software system 100 and the candidate software update are expressed in an extended formal language (e.g., NSO), which is an extension of one or more base formal languages. Each base formal language is any suitable formal language. The extended formal language is obtained or defined as described herein. In particular, the base formal language is extended to include a plurality of constant symbols, each corresponding to a respective logical equivalence class of sentences in the base formal language. Here, the extended formal language and each base formal language, regarded as a Boolean Algebra under logical equivalence, is elementarily equivalent under a signature of Boolean Algebra.

In this example, the candidate software update corresponds to an update sentence u in the extended formal language. At the next step 404 of the method, the software system 100 computes a truth value (e.g., 0 or 1) for uc′=0 in the extended formal language. That is, the expression uc′=0 is evaluated. Here, the condition element c, in the extended formal language, specifies a condition to validate the candidate software update, and uc′ is the logical conjunction of u with the logical negation of c.

In the next step 406 of the method, the candidate software update is rejected if uc′=0 is determined to be false. On the other hand, if uc′=0 is determined to be true, then the method involves, at step 408, accepting the candidate software update, and installing the candidate software update on the computing device 200 (e.g., to update the software system 100).

The present method benefits from supporting or allowing a candidate software update that includes an update to the condition element c that the update must satisfy for it to be acceptable. Indeed, if the update is deemed to be acceptable, and is therefore installed, then the condition element is updated so that subsequent candidate software updates are evaluated against the updated condition to determine if the subsequent update is acceptable for installation.

In some embodiments where the candidate software update is rejected, the method includes determining whether a modified version of the candidate software update can be accepted (and installed). For instance, a candidate software update may include parts (i), (ii), and (iii), and it may be determined that part (iii) contradicts the condition to be satisfied for the candidate software update to be acceptable. Parts (i) and (ii), however, may not contradict the condition. In this case the software system may modify the candidate software update to only include parts (i) and (ii), and instead install this modified version of the software update. In the extended formal language, the modified software update may correspond to a logically maximal sentence v, that is logically entailed by the original update sentence u, and that satisfies vc′=0. The sentence vc′ is the logical conjunction of v with the logical negation of the condition c. Here, it is noted that a skilled person would understand that logical entailment and logical maximality are well defined in mathematical logic.

The present method benefits from allowing the software system 100 to make modifications or adjustments to a received candidate software update prior to evaluating the update against the conditions to be satisfied. That is, the method may include modifying a received candidate software update to obtain a further candidate software update corresponding to a further update sentence w in the extended formal language. Here, the further update sentence w is obtained based on a suitable formula in the extended formal language that relates the update sentence u to the further update sentence w. The modification may be of any suitable form, and may be for any suitable purpose. The modification can be to narrow or extend the scope of the software update in a particular way, such as attempting to ensure that the (modified) update satisfies the condition in order to permit installation thereof.

The methods disclosed herein may be applied to various problems. In some embodiments, the methods can be implemented computationally to determine whether a contract has clauses that are inconsistent. The disclosed methods are also applicable to software specifications. When undertaking large software development projects, it is crucial to start by writing down a detailed description, or documentation, of the functional and non-functional requirements, constraints, and behaviors of the desired software system. These specifications serve as a blueprint or a contract between stakeholders, such as software developers, designers, project managers, and clients, to ensure that everyone has a clear understanding of what the software is supposed to do and how it should behave. A team of software developers then takes these software specifications (also known as “specs”) and turns them into step-by-step instructions for computers to execute. This is a typical software development process. This last step may be executed by first expressing all the specifications in NSO language specifications. An interpreter is then able to “execute” the specification directly. The obtained specifications are the programs to be executed.

The disclosed methods are also applicable to computer security. One challenge in computer security is often evolving a computer system while preserving its security and integrity. This is very hard to do in a computer system defined using procedural languages, as one would have to consider the possible execution of all the procedures in any order and on a large range of inputs. This is a practically impossible task. In contrast, a software system built on specifications as described above is guaranteed to maintain its security after each alteration or new functionality is added because all system specs and constraints are automatically maintained by the run-time of the disclosed system.

The disclosed methods are also applicable to computer-aided design (CAD) systems. CAD systems are a special case of KRR systems specialized in representing and reasoning on mechanical or electrical engineering designs. In this context, systems often have constraints in terms of required outputs (the performance of the system) while respecting general engineering constraints such maximum stress levels, maximum temperature, electrical currents, and so on. All of these requirements and constraints can be captured and maintained as extended formal language specifications, as described above.

As described above, no previously known knowledge representation and reasoning (KRR) system language (or logic in general) can consistently handle statements in its own language, combining them with other sentences, and referring to whether they contain a contradiction, or entail each other, and so on for other logical questions. The NSO language described herein is the first language capable of doing so, and not only in a consistent way, but even in a decidable way.

The expression “X said Y” might be stated in some language L1, while the expression “Y” might be expressed in a different language L2. In this case, L2 would be less expressive than L1. In fact, L2 is much less expressive because L1 can interpret L2. Next, consider the statement “X said that ‘Y said Z’”? This would then need three languages. Following this pattern, it leads to an impractical result, and even impossible to some extent. In the NSO solution described herein, there is provided languages such that L1=L2, and this is achieved by abstracting sentences to merely Boolean Algebra elements (and possibly slightly beyond).

To perform logical tasks in the novel language NSO, novel methods in the field of Boolean Algebra are also described herein. Moreover, NSO is not one language, but a language extension mechanism. The methodology creates infinitely many languages that satisfy this unique and novel property. Moreover, NSO can extend many languages together simultaneously in the same language. Therefore, NSO also provides a novel method of combining logics without breaking their consistency and decidability properties.

### 1—BACKGROUND

Automated theorem proving and equation solving is of widespread use in engineering, such as the markets of Formal Methods (e.g., Formal Verification), Knowledge Representation and Reasoning (KRR), Artificial Intelligence (AI), and more. It is useful to find algorithms that allow solving and/or determining the existence of solutions and/or truth values of statements in various formal languages. This application uses the language of Boolean Algebras under some generalized definitions of such a language and presents various methods to solve problems that can be expressed in Boolean Algebras. The techniques can be used in all of the above industries, as well as more.

Decidability of the standard theory of Boolean Algebra was addressed long ago by Tarski. Methods here utilize extensions of the standard theory, including:
1) Allowing constants to be arbitrary elements and not limited to the values 0 and 1;
2) Quantification over Boolean Functions, Simple Boolean Functions, and their higher order counterparts;
3) Cartesian products;
4) Homomorphisms;
5) Recurrence relations; and
6) Converse of binary relations.

The techniques used here also include:
1) Finding an explicit zero of a Boolean function;
2) Optimization of Boolean functions with respect to cardinality and the order induced by the Boolean Algebra; and
3) Quantifier elimination.

### 2—TERMINOLOGY, NOTATION, AND BASIC DEFINITIONS

A Boolean Ring is a ring with unity satisfying xx=x for each element x. A Boolean Function (BF) is a polynomial over a Boolean Ring. If the coefficients of a Boolean Function are only 0 or 1, then it is called a Simple Boolean Function (SBF). A Boolean Algebra is a Boolean ring where the operations are ∧, ∨, and ′. These operations are interpreted in the language of rings as x∧y≡xy, x∨y≡x+y+xy, and x′≡1+x. Similarly x+y=xy′∨x′y. Note that the symbol “+” denotes the symmetric difference, which corresponds to an exclusive OR (XOR).

The symbols ∧ and ∨ are also used as logical connectives. The usage as operations or logical connectives will be clear from the context. For example, in x∨y=0 ∨y≠0, the first “∨” is a function symbol in the theory of Boolean Algebra and the second “∨” is a logical connective.

The Boolean derivative of a Boolean Function is defined by ∂f(x)/∂x=f(0)+f(1).

A minterm in n variables, denote by X^{A}, is a product

$${x}_{1}^{{a}_{1}} {x}_{2}^{{a}_{2}} … {x}_{n}^{{a}_{n}} ,$$

where A∈{0, 1}ⁿ is a tuple A=a₁, . . . , aₙ and

$${x}_{i}^{{a}_{i}} = {x}_{i}$$

when aᵢ=1 and

$${x}_{i}^{{a}_{i}} = {x}_{i}^{′}$$

when aᵢ=0. It is well known that any Boolean Function can be written as a sum (equivalently, disjunction) of minterms multiplied by respective constant coefficients. As used herein, this is referred to as a “minterm normal form,” although some authors refer to this as “canonical DNF.” The term “minterm” might be a minterm coupled with a constant coefficient, as should be clear from the context.

The [first order] theory of Boolean Algebra is always considered interpreted in some specific Boolean Algebra, and the language is extended with constant symbols for all Boolean Algebra elements. The interpretation matches each constant symbol to its corresponding Boolean Algebra element. This is different from other common authors on the subject. Commonly, authors consider the first order theory of Boolean Algebras (whether generic or specific or certain classes thereof), where the only constant symbols are 0 and 1. This application deals with a quantified system of equations and inequations. While in other authors' formalisms the atomic formulas are of the form “some Simple Boolean Function equals zero,” the present application deals with the more general construct of determining when “some Boolean Function equals zero.”

Further the present application considers the many-sorted theory of Boolean Algebras. That is, fix some Boolean Algebras, and obtain the first order theory in which each variable has a type that denotes the Boolean Algebra it should come from (it is also easy to not require explicit typing and interpret the formula mutatis mutandis). Such a theory is interpreted in a product of structures. Variables and constants in a single atomic formula may refer only to one Boolean Algebra, but a combination of atomic formulas from various Boolean Algebras is possible.

As customary, it is possible to define a partial order in Boolean Algebras by defining x≤y if and only if xy=x. An element a is defined to be an atom if 0≤x≤a implies x=0 or x=a, for all x in the Boolean Algebra. A Boolean Algebra is atomless if it has no atoms.

As an example of the above, pick an atomless Boolean Algebra such as the finite unions of left-closed-right-open intervals over the rational numbers. Boolean Functions in this algebra have coefficients that are written in some explicit form, such as [a, b), where a and b are rational numbers. An example of a first order formula (in the disclosed generalized fashion) is ∀x∃y. [1, 2)′x≠[0.1, 6.8)∨y.

It is sometimes useful to refer to Boolean Algebra elements as sets (e.g., when speaking about their cardinality). Such a representation is guaranteed by Stone's Representation Theorem for Boolean Algebras. In fact, an equivalent way to define Boolean Algebras is as a set of sets that are closed under finite unions, finite intersections, and complementation. Every power set is therefore a Boolean Algebra, but there are Boolean algebras that are not power sets. Such latter Boolean Algebras must be infinite.

Just as Boolean Functions can have minterm normal form as above, formulas can also have a similar form. Any atomic formula has the form f(X)=0, so writing f as a disjunction of minterms enables considering only atomic formulas of the form X^{A}=0, since x∨y=0 is same as x=0∧y=0.

### 3—METHOD OF FINDING A ZERO OF A FORMULA

Consider a Boolean Function in Boole normal form (sometimes called Shannon's decomposition). This can be written as ƒ(x,X)=xg(X)+x′h(X) or equivalently ƒ(x,X)=xg(X)∨x′h(X), where X is a tuple of n variables. Assuming it has a zero, Boole's consistency condition holds:

$$[ {∧}_{{{x ∈ \{}_{}}_{0 , 1 \}}} {∧}_{X ∈ {\{ , 1 \}}^{n}} f ( x , X ) ] = 0$$

A specific zero is identified inductively as follows. Let Z be a zero of g(Z) h(Z) (which is guaranteed to exist by Boole's consistency condition). Then both ƒ(h(Z), Z)=0 and ƒ(g′(Z),Z)=0. Therefore, one zero can be found inductively by choosing one of those two arbitrarily (or by choosing the shortest case or any other optimization). Finding a single zero enables characterizing all zeros by Lowenheim's General Reproductive Solution.

### 4—OPTIMIZATION METHODS

Determining whether |ƒ(x)|=n has a solution for some Boolean Function f and finding its minimum and maximum cardinalities (which happen to coincide with minima and maxima induced by the Boolean Algebra) can be performed as follows.

The equation |ƒ(x)|=n has a solution if and only if |ƒ(0)ƒ(1)|≤n≤|ƒ(0)∨ƒ(1)|. More generally, let ƒ(x) be a Boolean Function. Then the minimum of |ƒ(x)| (as well as its minimum with respect to the order induced by the Boolean Algebra, which happens to always exist) is attained precisely when ƒ(0)ƒ′(1)≤x≤ƒ(0)∨ƒ′(1) and the maximum precisely when ƒ′(0)ƒ(1)≤x≤ƒ′(0)∨ƒ(1).

### 5—QUANTIFIER ELIMINATION METHOD IN ATOMLESS BOOLEAN ALGEBRAS

Given a formula in the language of atomless Boolean Algebras, first pick an innermost quantifier and assume it is existential (otherwise, convert it to existential by negation). Consider the corresponding subformula and assume it is in disjunctive normal form (DNF):

$$∃ x . {∨}_{i} ( {∧}_{j} [ {f}_{ij} ( x , X ) = 0 ] ∧ {∧}_{k} [ {g}_{ik} ( x , X ) \neq 0 ] )$$

where each ƒᵢⱼ and gᵢₖ is a Boolean Function (not necessarily a Simple Boolean Function), interpreted in some fixed atomless Boolean Algebra (it is fixed so that the constants that are not 0 or 1 are correctly interpreted). First, convert it to the form:

$$∃ x . {∨}_{i} ( [ {f}_{i} ( x , X ) = 0 ] ∧ {∧}_{k} [ {g}_{ik} ( x , X ) \neq 0 ] )$$

(where the f's are not the original ones) by noting that

$$[ {∧}_{i} {h}_{i} ( X ) = 0 ] if and only if [ {∨}_{i} {h}_{i} ( X ) ] = 0$$

for all Boolean Functions hᵢ, as is well known. The resulting formula is logically equivalent to each of the following:

$${∨}_{i} [ {f}_{i} ( 0 , X ) {f}_{i} ( 1 , X ) = 0 ∧ {∧}_{k} ( ( {g}_{ik} ( {f}_{i} ( 0 , X ) , X ) ∨ {g}_{ik} ( {[ {f}_{i} ( 1 , X ) ]}^{′} , X ) ) ) \neq 0 ]$$

$$and$$

$${∨}_{i} [ {f}_{i} ( 0 , X ) {f}_{i} ( 1 , X ) = 0 ∧ {∧}_{k} ( {g}_{ik} ( 0 , X ) {g}_{ik} ( 1 , x ) \to \frac{\partial {[ {f}_{i} ( x , X ) ]}^{′} {g}_{ik} ( x , X )}{\partial x} ) \neq 0 ]$$

$$and$$

$${∨}_{i} [ {f}_{i} ( 0 , X ) {f}_{i} ( 1 , X ) = 0 ∧ {∧}_{k} ( {f}_{i}^{′} ( 0 , X ) {g}_{ik} ( 0 , X ) ∨ {f}_{i}^{′} ( 1 , X ) {g}_{ik} ( 1 , X ) ) \neq 0 ]$$

### 6—QUANTIFIER ELIMINATION METHOD IN BOOLEAN ALGEBRAS HAVING ATOMIC ELEMENTS

Existential quantifiers can be eliminated in Boolean Algebras with atomic elements as well. In this case, each element may be written as a (possibly infinite) disjunction of atoms. Powerset algebras are the main example of such algebras. Note that cardinality here coincides with the number of distinct atoms required to construct a given element.

First, as shown above, bring the subformula into the form

$$∃ x . {∨}_{i} ( [ {f}_{i} ( x , X ) = 0 ] ∧ {∧}_{k} [ {g}_{ik} ( x , X ) \neq 0 ] )$$

Then, rewrite this as

$${∨}_{i} [ [ {f}_{i} ( 0 , X ) {f}_{i} ( 1 , X ) = 0 ] ∧ ∃ x . {∧}_{k} [ {g}_{ik} ( x + {f}_{i} ( x , X ) , X ) \neq 0 ] ]$$

Next, convert this formula to minterm normal form, obtaining a series of inequations of the form a₁x≠0, a₂x≠0, . . . , a_{N}x≠0, b₁x′≠0, b₂x′≠0, . . . , b_{K}x′≠0 by simple conversion into disjunctive normal form (DNF) and noticing that such a conversion does not require negations (only distributing conjunctions and disjunctions over each other), so no inequality is turned into equality. Note that a; and b; here are minterms in X, although a more general form is also suitable in this treatment.

The system a₁x≠0, a₂x≠0, . . . , a_{N}x≠0, b₁x′≠0, b₂x′≠0, . . . , b_{K}x′≠0 over any Boolean Algebra has a solution if and only if it has a solution of cardinality at most N (and if K is smaller, then it can have a solution for x′). The method is to therefore convert the formula to one over a finite Boolean Algebra and possibly subsequently to the two-element Boolean Algebra. When a single quantifier ax is to be eliminated, it can therefore be written as log N quantifiers ranging over only 0 and 1, which can in turn be eliminated into disjunctions, therefore yielding a proper quantifier elimination as needed.

Let X^{A}^{₁}, . . . , X^{A}^{ₘ} be minterms in n variables, and b₁, . . . , bₘ elements in some BA. Then

$$∃ X . {∧}_{i = 1}^{m} {X}^{{A}_{i}} \geq {b}_{i}$$

if bᵢbⱼ=0 whenever Aᵢ≠Aⱼ.

Algorithm: First assume that X^{A}^{₁}, . . . . X^{A}^{ₘ} are all distinct and therefore the nonzero b's are all disjoint, otherwise convert any two equations of the form

X^{A}^{ᵢ}≥s

X^{A}^{ᵢ}≥t

into the equivalent form X^{A}^{ᵢ}≥s∨t. Necessity is now immediate recalling that two different minterms are always disjoint and that subsets of disjoint sets must also be disjoint. For sufficiency and n=1 the equations take the form x≥b₁ and x′≥b₂ which indeed holds if b₁b₂=0. Assume for n and consider an additional variable x. Then we can split the equations into p+q=m equations and rewrite them as

$${\{ {xX}^{{A}_{i}} \geq {b}_{i} \}}_{i = 1}^{p}$$

$${\{ {x}^{′} {X}^{{B}_{j}} \geq {c}_{j} \}}_{j = 1}^{q}$$

and let X be a solution of

$${\{ {X}^{{A}_{i}} \geq {b}_{i} \}}_{i = 1}^{p}$$

$${\{ {X}^{{B}_{j}} \geq {c}_{j} \}}_{j = 1}^{q}$$

by the induction hypothesis after making sure that all Aᵢ, Bᵢ are disjoint (while if p+q=1 then a solution trivially exists). If p≠0, set x=∪ₖbₖ. Then ∪ₖcₖ≥x′ due to the disjointness assumption. Therefore

$${xX}^{{A}_{i}} = ( {⋃}_{k} {b}_{k} ) ∧ {X}^{{A}_{i}} \geq {b}_{i} {X}^{{A}_{i}} = {b}_{i}$$

$${x}^{′} {X}^{{B}_{j}} \geq ( {⋃}_{k} {c}_{k} ) {X}^{{B}_{j}} \geq {c}_{j} {X}^{{B}_{j}} = {c}_{j}$$

Similarly set

$$x = {⋂}_{k} {c}_{k}^{′}$$

if p=0, or simply x=0.

The system

$${\{ {b}_{i} {X}^{{A}_{i}} \neq 0 \}}_{i = 1}^{m}$$

has a solution in there exists 0<cᵢ≤bᵢ s.t. cᵢcⱼ=0 whenever Aᵢ≠Aⱼ.

In atomless BA, the system

ƒ(x)=0∧g(x)=0

has a solution if

ƒ(0)ƒ(1)=0∧g(x+ƒ(x))=0

has a solution.

In atomless BA, the system

$$f ( x ) = 0 ∧ {∧}_{i ∈ I} {g}_{i} ( x ) \neq 0$$

has a solution if

$$f ( 0 ) f ( 1 ) = 0 ∧ {∧}_{i ∈ I} {g}_{i} ( f ( 0 ) ) ⋃ {g}_{i} ( {f}^{′} ( 1 ) ) \neq 0$$

has a solution.

In any BA, x is a solution of the elementary GSBE

$$f ( x ) = 0 ∧ {∧}_{i} {g}_{i} ( x ) \neq 0$$

if it's a solution of the GSBE

ƒ(x)=0 ∧∧ᵢxƒ′(1)gᵢ(1)≠0∨x′ƒ′(0)gᵢ(0)≠0 (2.1.1)

if it's a solution of the GSBE

ƒ(0)ƒ(1)=0∧ƒ(x)=0∧ (2.1.2)

$${∧}_{i} {g}_{i} ( 0 ) {g}_{i} ( 1 ) \neq 0 ∨ {xf}^{′} ( 1 ) {g}_{i} ( 1 ) \neq 0 ∨ {x}^{′} {f}^{′} ( 0 ) {g}_{i} ( 0 ) \neq 0$$

In atomless BA, the system

$$f ( x ) = 0 ∧ {∧}_{i} {g}_{i} ( x ) \neq 0$$

has a solution if

$$f ( 0 ) f ( 1 ) = 0 ∧ {∧}_{i} {f}^{′} ( 1 ) {g}_{i} ( 1 ) ⋃ {f}^{′} ( 0 ) {g}_{i} ( 0 ) \neq 0$$

In atomless BA, the system

$$f ( x ) = 0 ∧ {∧}_{i} {g}_{i} ( x ) \neq 0$$

has a solution if

$$f ( 0 ) f ( 1 ) = 0 ∧ {∧}_{i} {f}^{′} ( x ) {g}_{i} ( x ) \neq 0$$

The system

$${\{ {a}_{i} x \neq 0 \}}_{i = 1}^{N} , {\{ {b}_{j} {x}^{′} \neq 0 \}}_{j = 1}^{K}$$

has a solution if there exist atoms sᵢ, tⱼ s.t.

$${\{ {s}_{i} \leq {a}_{i} \}}_{i = 1}^{N} , {\{ {t}_{j} \leq {b}_{j} \}}_{j = 1}^{K} , ∀ ij . {s}_{i} \neq {t}_{j}$$

in which case any

$${⋃}_{i} {s}_{i} \leq x \leq {⋂}_{j} {t}_{j}^{′}$$

is a solution.

The system

$${\{ {a}_{i} x \neq 0 \}}_{i = 1}^{N} , {\{ {b}_{j} {x}^{′} \neq 0 \}}_{j = 1}^{K}$$

has a solution if it has a solution of cardinality at most N.

A formula in the language of BA containing n variables interpreted over [symbol] is true if it's true in an algebra of size 2²^{ⁿ⁻¹}.

To this end, we relativize quantifiers successively as follows. Without loss of generality we deal only with existentially quantified single DNF clause of the form

$$∃ x \cdot f ( x ) = 0 ∧ {∧}_{i} {g}_{i} ( x ) \neq 0$$

which can be written as:

$$[ f ( 0 ) f ( 1 ) = 0 ] ∧ ∃ x \cdot {∧}_{i} {g}_{i} ( x + f ( x ) ) \neq 0$$

and can be converted into the form:

$$[ f ( 0 ) f ( 1 ) = 0 ] ∧ ∃ x \cdot {∧}_{i} {a}_{i} x \neq 0 ∧ {∧}_{i} {b}_{i} {x}^{′} \neq 0$$

where aᵢ, bᵢ are minterms in the remaining variables. Since there are no more than 2ⁿ⁻¹ minterms in the n variables excluding x, this formula can be relativized as:

$$[ f ( 0 ) f ( 1 ) = 0 ] ∧ ∃ \vert x \vert \leq {2}^{n - 1} \cdot {∧}_{i} {a}_{i} x \neq 0 ∧ {∧}_{i} {b}_{i} {x}^{′} \neq 0$$

The system

{xX^{A}^{ᵢ}=0}_{i∈I}_{₁}

{x′X^{B}^{ᵢ}=0}_{i∈I}_{₂}

{xX^{C}^{ᵢ}≠0}_{i∈I}_{₃}

{x′X^{D}^{ᵢ}≠0}_{i∈I}_{₄}

has a solution in atomless BA if all of the following conditions hold:
1. no Aᵢ equals Cᵢ,
2. no Bᵢ equals Dᵢ,
3. no X^{C}^{ᵢ}, X^{D}^{ᵢ} is zero,
4. X^{A}^{ᵢ}=0 whenever Aᵢ=Bⱼ,
   in which case a solution is x=∪ⱼtⱼ∪∪ₘX^{B}^{ₘ} for any 0<tᵢ≤X^{C}^{ᵢ}.

The system

$${∧}_{i} {a}_{i} {X}^{{A}_{i}} = 0$$

$${∧}_{i} {b}_{i} {X}^{{B}_{i}} \neq 0$$

has a solution if

$${∧}_{i} {b}_{i} {⋂}_{j \vert {A}_{j} = {B}_{i}} {a}_{j}^{′} \neq 0$$

$$equivalently$$

$${∧}_{i} {b}_{i} ≰ {⋃}_{j \vert {A}_{j} = {B}_{i}} {a}_{j}$$

X satisfies

$${∧}_{i} {a}_{i} {X}^{{A}_{i}} = 0$$

$${∧}_{i} {b}_{i} {X}^{{B}_{i}} \neq 0$$

if it satisfies

$${∧}_{i} {a}_{i} {X}^{{A}_{i}} = 0$$

$${∧}_{i} {b}_{i} {X}^{{B}_{i}} {⋂}_{j \vert {A}_{j} = {B}_{i}} {a}_{j}^{′} \neq 0$$

$$If$$

$${∧}_{i} {a}_{i} {X}^{{A}_{i}} = 0$$

$${∧}_{i} {b}_{i} {X}^{{B}_{i}} \neq 0$$

has a solution, namely if

$${∧}_{i} {b}_{i} {⋂}_{j \vert {A}_{j} = {B}_{i}} {a}_{j}^{′} \neq 0 ,$$

then a solution can be obtained by choosing

$$0 < {c}_{i} \leq {b}_{i} {⋂}_{j \vert {A}_{j} = {B}_{i}} {a}_{j}^{′}$$

where

Bᵢ≠Bⱼ→cᵢcⱼ=0

and then solving

$${∧}_{i} {a}_{i} {X}^{{A}_{i}} = 0$$

$${∧}_{i} {c}_{i} {X}^{{B}_{{i}^{′}}} = 0$$

A strong normalization algorithm would follow: given a quantifier-free formula, convert it to MNF+BDD form, which means that atomic formulas are of the form aX^{A}=0, and the formula is a BDD of atomic formulas. Now go over all paths in that BDD. To each path:
(1) Squeeze positive atomic formulas of the form aX^{A}=0 and bX^{A}=0, namely ones with equal exponent.

(2) Apply the normalization in corollary 3.1.

(3) Treat all atomic formulas with zero coefficient.

(4) Discard the path if it makes an unsatisfiable system of equations.

In atomless BA, there exists x s.t.

a≤x≤b

{cᵢ [symbol] x}_{i∈I}

{x [symbol] dⱼ}_{j∈J}

if for all i,

cᵢ [symbol] a≤b [symbol] dⱼ

In a system {cᵢ [symbol] x}_{i∈I}∧{x [symbol] dⱼ}_{j∈J}, a necessary and sufficient condition that x=ƒ(C, D), for some BFf, is a solution, is:
(1) for all i∈I exists Pᵢ∈{0,1}^{|I|}, Qᵢ∈{0,1}^{|J|} s.t. pᵢ=1 and ƒ(Pᵢ, Qᵢ)≠1, and
(2) for all j∈J exists Uⱼ∈{0,1}^{|I|}, Vⱼ∈{0,1}^{|J|} s.t. vⱼ=0 and ƒ(Uⱼ, Vⱼ)=0.

If the system {cᵢ [symbol] x}_{i∈I}∧{x [symbol] dⱼ}_{j∈J} has a solution, and if x satisfies

∀AB·C^{A}D^{B}≠0→xC^{A}D^{B}≠0∧x′C^{A}D^{B}+0

alternatively

$$x = {⋃}_{A , B} 𝒮 ( {C}^{A} {D}^{B} )$$

then x is a solution.

If the system {cᵢ [symbol] x}_{i∈I}∧{x [symbol] dⱼ}_{j∈J} has a solution, and if x satisfies

$$x = {⋃}_{A , B ∈ 𝒯} 𝒮 ( {C}^{A} {D}^{B} )$$

when [symbol] is a set of pairs of bitstrings containing each cᵢ positively at least once and each dⱼ negatively at least once, and s.t. C^{A}D^{B} is nonempty for all A, B∈ [symbol] , then x is a solution. Moreover, such an x always exists.

### Cardinality

In what follows ƒ(x)=ax+bx′ is any Boolean function.

The equation |ƒ(x)|=n has a solution if |ab|≤n≤|a∪b|.

The following theorem is a strong and useful generalization of Boole's consistency condition:

Let ƒ(x) be a Boolean function. Then the minimum of |ƒ(x)| is attained precisely when

a′b≤x≤a′∪b

and the maximum precisely when

ab′≤x≤a∪b′

### Cartesian Product

Given an expression involving ∪, ∩, ′, × and constants and variables, where × is interpreted over the sets underlying the BA elements (as guaranteed by Stone's representation theorem for BAs, alternatively over any BA interpreted over fixed sets), and whenever this expression typechecks so cartesian product of e.g. two elements cannot interact as-is with a cartesian product of e.g. three elements, we can use the well known identities

(ab)×(cd)=(a×c)(b×d)

(a×b)′=(a′×b′)∪(a×b′)∪(a′×b)

(or similar identities widespread in literature) to push x to the innermost level in the expression. Then given a first order formula, we can make the BF appearing in each atomic formula take e.g. the form of disjunctions of cartesian products of minterms. We now convert the formula to minterm normal form (or a weaker form based on DNF of BFs). Now pulling out × over the conjunctions in each clause, we know that the product equals the empty set if at least one multiplicand is empty, which would be a disjunction of formulas without ×.

Note that this allows cartesian product of elements from different BAs as in the many-sorted theory of BAs.

### Higher-Order Boolean Functions

It is possible to quantify over BFs, SBFs, and certain CBFs (conditional BFs as below), and their higher order counterparts, and obtain an equivalent formula without quantification over functions, using the following method. Consider a formula involving existential (or universal, mutatis mutandis) quantification ∃ƒ over such functions. Each BF of n variables can be written as a Boolean expression involving 2ⁿ constants (e.g. by using Boole's normal form or algebraic normal form or minterm normal form, per subexpression considering a single variable, or over the whole expression considering all variables), so quantification over BFs is converted into 2ⁿ first order quantifiers. Similarly for SBFs we quantity over constants and require them to be either 0 or 1. A CBF is a Boolean expression that involves the ceiling function defined by taking zero to zero and all other BA elements to one, or even more generally, a formula in the language of BA that is interpreted as the values 0,1 in the BA (which is the same as allowing quantifiers and equality/inequality under the ceiling function). In their full generality, CBFs may involve unboundedly many coefficients. Restricting them, e.g. by requiring that expressions under the ceiling function (or in formulas) must be SBFs, or requiring constants to be taken from some fixed finite set, allows a quantifier elimination into first order in the same fashion as above.

Higher order functions (BF, SBF, and restricted CBF) are seen as operating over the coefficients of their input (possibly higher order) functions and returning coefficients, and are therefore translated accordingly, so a higher order function that takes a BF of n variables and returns a BF of n variables, will be written as a function that takes 2ⁿ BA elements and returns 2ⁿ elements, with all necessary adjustment for all cases, mutatis mutandis, and similarly for a function that takes a function of functions, and so on.

For efficiency, there is no need to expand the formula exponentially (or a tower of exponentials) right at the beginning, but it can be done step-by-step with opportunities for simplifications and eliminations in each step, in the following fashion: a quantifier over a BF of n variables can be converted to a quantification over two BA elements and over two BFs over n−1 variables, simply by writing down the Boole's normal form (or any other form e.g. Reed-Muller) for the quantified function w.r.t. one (possibly cleverly chosen) variable.

Second order finite model checking can be rewritten as quantification over SBFs.

### Homomorphisms and Hemimorphisms

The many-sorted theory of Boolean Algebra allows interaction between distinct Boolean Algebras only by means of combining atomic formulas. Even the above Cartesian product that allows mixing different Boolean Algebras still allows a very shallow interaction between them. However, a deeper interaction can be made and is still decidable, using a decision method described now. This is useful not only for interaction between Boolean Algebras, but even as an extension of the theory of a single Boolean Algebra. Further, it trivially has uses (including a decision procedure) in various languages called Description Logics (DLs), which are commonly used in KRR.

In what follows we will deal with existential formulas of the form

$$ϕ ≡ ∃ {x}_{1} , … {x}_{n} \cdot f ( X ) = 0 ∧ {∧}_{j} {g}_{i} ( X ) \neq 0 ∧ {∧}_{i} {ψ}_{i}$$

where each ψᵢ is of the form x=hⱼ(y) where x, y may be constants, or taken from x₁, . . . xₙ. hⱼ here is either a BA homomorphism or a monoid homomorphism (as we shall describe shortly), and the rest of φ is the general form of a DNF clause in the language of BA. We will transform φ to a formula which does not contain hⱼ.

Here we support the many-sorted theory of BA, so it is interpreted in the product of multiple BAs, and the homomorphisms may be between different BAs. In particular we can support ultrafilters which are nothing but homomorphisms into the two-element BA.

A homomorphism here is simply a ring homomorphism. The term hemimorphism is used by Halmos and is defined by:

A function h: [symbol] between two BAs is a hemimorphism if h(0)=0 and h(x∪y)=h(x)∪h(y) for all x, y.

Any hemimorphism gives rise to a monoid homomorphism, where the monoid is the multipicative monoid in the BR. Put g(x)=h′(x′). Then g(1)=1 and

g(xy)=h′(x′∪y′)=(h(x′)∪h(y′))′=h′(x′)h′(y′)=g(x)g(y)

This is the same as existential and universal quantifiers in description logic, where h is seen as a binary relation, and BA elements are seen as unary relations. We will emphasize on this connection later on.

We therefore assume that each hⱼ in the original formula is either a homomorphism or a hemimorphism, which includes the case of monoid homomorphism. Further, we can also cover isomorphisms, by requiring that a homomorphism has an empty kernel and that it sends 1 to 1, by a modification of the technique below.

First we convert ∧ᵢψᵢ into the form

$${∧}_{( i , j , k ) ∈ I} [ {⋃}_{A ∈ {𝒜}_{i}} {c}_{A} {X}^{A} ] = {h}_{j} ( {d}_{k} {X}^{{B}_{k}} )$$

where c_{A}, dₖ are constants. This translation is straight-forward by writing each element as a disjoint union of minterms, and relying on the fact that hⱼ distributes over unions.

We now get a finite partition of the BA where the disjoint parts are the minterms. We can walk over the graph defined by which minterm is sent to which. The only additional condition we have to add is

$${d}_{k} {X}^{{B}_{k}} = 0 \to {⋃}_{A ∈ {𝒜}_{i}} {c}_{A} {X}^{A} = 0$$

with the initial condition dictated by ƒ(X) saying which minterms must be zero, and this readily comes down to a method to eliminate the hemimorphisms.

For homomorphisms we add the following condition: disjoint elements are sent to disjoint elements, namely xy=0→h(x)h(y)=0. This can again be checked by walking on the graph of which minterm is sent to which.

However in BAs that are not atomless, another cardinality condition has to be added. This and other results required for those algorithms are summarized in the following theorem:

If x₁, . . . , xₙ are nonzero and disjoint then there is a hemimorphism h s.t. ∀i. yᵢ=h(xᵢ) for arbitrary y₁, . . . , yₙ. Under the same setting, and if the BA is complete or countable atomless, a homomorphism exists if yᵢyⱼ=0 for all i≠j, and |xᵢ|≤|yᵢ|.

|x| refers to cardinality, and in pure BA terms, it is the supremum of how many disjoint sets x can be written as a union thereof.

Set h to send anything in [∪ᵢxᵢ]′ to zero, and for hemimorphisms for all 0<tᵢ≤xᵢ, set h(tᵢ)=yᵢ. The rest is immediate. For homomorphisms, if the BA is complete then this follows from theorem 5.13 in [kop]. we use Stone's duality in its topological setting, recalling that a homomorphism is the [set] inverse of continuous functions (in the Stone topology), and vice versa. We have to find a continuous function ƒ s.t. ∀i. yᵢ=ƒ⁻¹(xᵢ). But this already says that certain clopen sets are sent to clopen sets, and disjoint sets are sent to disjoint sets, so as long as the preimage of each set is not smaller (in terms of cardinality) than the original set (and in atomless BA all clopen sets are infinite), there exists an continuous extension of this function over the whole space. In particular we can again set h to send anything in [∪ᵢxᵢ]′ to zero.

In the above algorithms, the cardinality constraint has to be clearly addressed, e.g. by not fixing the underlying BA and allowing it to be infinite (which will require a careful consideration of the constants), or by considering an atomless BA so the cardinality of each element is either zero or infinite.

Consider a special case of Tarski's Calculus of Relations as follows. Consider the powerset algebra of sets of pairs over some domain D. The algebra is P(D x D). Consider the theory of Boolean Algebra of this algebra enhanced with another operation R⁻ taking a binary relation R to its converse (aka inverse or transpose). That is ∀xy. Rxy↔R⁻yx.

Consider two such algebras: general and diagonal-free. Diagonal-free means that no binary relation has a diagonal, namely ∀x.¬Rxx. Complementation is then understood correspondingly, taking the complement but leaving the diagonal yet empty. In the general case R_{d} denotes the diagonal of R, and R_{-d} is (R_{d})′ R. A polynomial is any finite combination of elements by means of Boolean operations and converse. Described now is a method to determine whether such a polynomial has a zero.

A converse algebra is defined as “complete” if every diagonal-free relation has a maximal asymmetric part. Every powerset algebra as defined above is complete, and the method extends to other complete converse algebras as well.

Note that a polynomial in R is a Boolean Function of the form f(R, R⁻). Put A=f (1, 1), B=f(1, 0), C=f(0, 1), and D=f(0, 0). Then a method to determine whether ∃R.f(R,R⁻)=0 is to check whether (A∨A⁻)(B∨C⁻)(C∨B⁻)(D∨D⁻)=0, and this for diagonal-free algebras only. In this case any R=A′A⁻′∨T is a solution, where T is a maximal asymmetric part of B′C⁻′.

For the general case, consider an even more generalized problem of a function that depends also on the diagonal. The general form of such a function is:

$$f ( {R}_{d} , R , {R}^{-} ) = {AR}_{d} + {BRR}^{-} {R}_{d}^{′} + {CRR}^{- ′} + {DR}^{′} {R}^{-} + {ER}^{′} {R}^{- ′}$$

A method to determine whether ∃R.f(R_{d}, R, R⁻)=0 is to check whether A_{d}E_{d}=0 and (B∨B⁻)(C∨D⁻)(C⁻∨D)E_{-d}=0.

In the notation above, it is useful to have an expression that expresses the intersection of all (possibly infinitely many) R's that satisfy ƒ(R, R⁻)=0 and similarly for ƒ(R_{d}, R, R⁻)=0. For the first case it is simply (D∨D⁻)(B⁻∨C) and for the second case it is (D∨D⁻)_{-d} (B⁻∨C)∨D_{d}.

Here we shall define a somehow nonstandard notion of query answering. In the field of Knowledge Representation (KR) a query would be an open formula, and the answer would be all substitutions that are entailed from the KB. Another way to say it, is that it refers to the part that is common to all models. So if the query is merely an atom of the form Rxy, then the answer resembles [symbol] M. There are some caveats here but the main takeaway is concerning the part that is common to all models indeed. Note that this need not be a model: consider the formula C (a)∧(C (b)∨C (c)), where C is a unary relation and a, b, c are constants. Then the part common to all models is only C (a). However, it is not a model, since every model will have to include either C (b) or C (c).

Our modified notion of query answering is as follows. Initially, the query is a single atom of the form Rxy. The answer is going to be a formula with two free variables, in which R does not appear, and for each substitution of the variables, the formula is a tautology if that substitution holds in all models of R. For example, the answer to the query Rxy over each of the two formulas ∀xy.Sxy→Rxy and ∀xy.Sxy↔Rxy is going to be Sxy. An intuitive way to look at it is that the answer gives an “explanation” that “explains” R without referring to R.

We model the KB as a statement of the form ƒ(R, R⁻)=0. The reason for that will be clear later. The coefficients A, B, C, D [, E] may depend on other variables and constants. We would like to express the query answer a being an R-free expression satisfying

$$α = {⋂}_{R \vert ( f ( R , {R}^{-} ) = 0} R$$

In a DFCA, if ∃R.ƒ(R, R⁻)=0, then

α=(D∪D⁻)(B⁻∪C)

### Infinitary Operations

The goal of this section is to present a method to explicitly evaluate the expressions

$${⋃}_{X \vert ϕ ( X )} f ( X )$$

$$and$$

$${⋂}_{X \vert ϕ ( X )} f ( X )$$

where X is a tuple of variables, ƒ is a BF, and φ is a GSBE with X as its unknowns. We focus on atomless BAs, while the treatment for general BAs is analogous yet more complex, as will be seen from some of the general following lemmas.

The method presented here is in particular useful for the first order theory of BA (possibly interpreted in a specific BA with a dedicated constant symbol to each element) enhanced with the above operations, while maintaining decidability, by reducing it to the standard BA theory.

It is already surprising that BAs, in particular atomless BAs, are even closed under the above [possibly] infinitary operations. As we shall see, the results take an even more surprisingly simple form.

Clearly, it is enough to compute ∪_{X|φ(X)}ƒ(X) since

$${⋂}_{X \vert ϕ ( X )} f ( x ) = {[ {⋃}_{X \vert ϕ ( X )} {f}^{′} ( x ) ]}^{′}$$

and vice versa. Further, note that

$$\begin{matrix}{⋃}_{{x}_{1} , … , {x}_{n} \vert ϕ ( {x}_{1} , … , {x}_{n} )} f ( {x}_{1} , … , {x}_{n} ) = {⋃}_{{x}_{1} \vert ϕ ( {x}_{1} , … , {x}_{n} )} {⋃}_{{x}_{2} , … , {x}_{n} \vert ϕ ( {x}_{1} , … , {x}_{n} )} f ( {x}_{1} , … , {x}_{n} ) \\ = {⋃}_{{x}_{2} , … , {x}_{n} \vert ϕ ( {x}_{1} , … , {x}_{n} )} {⋃}_{{x}_{1} \vert ϕ ( {x}_{1} , … , {x}_{n} )} f ( {x}_{1} , … , {x}_{n} )\end{matrix}$$

where in the last two equations x₁ cleary depends on x₂, . . . , xₙ. This shows that treating only the univariate case ∪_{X|φ(X)}ƒ(X) is sufficient.

For simplicity, all BAs in this section are assumed to be infinite. The finite case treatment can be done along the same lines. However at one point we'll strongly use the atomless assumption, in which case our main and final result, under a mild assumption on ƒ (namely that it doesn't have a unique zero, otherwise the answer is trivial), is

$${⋃}_{x \vert f ( x ) = 0 ∧ {∧}_{i} {g}_{i} ( x ) \neq 0} h ( x ) = h ( 1 ) {f}^{′} ( 1 ) ⋃ h ( 0 ) {f}^{′} ( 0 )$$

which, most remarkably, is not only a simple closed-form, but also does not depend on gᵢ. The intuition behind the latter point will be clear later on.

Let a∈ [symbol] , then

$${⋃}_{x ≰ a} x = \{ \begin{matrix}0 & a = 1 \\ 1 & a \neq 1\end{matrix}$$

$${⋂}_{x ≰ a} x = \{ \begin{matrix}1 & a = 1 \\ {a}^{′} & {a}^{′} is an atom \\ 0 & otherwise\end{matrix}$$

We assume that empty disjunction are 0 and empty conjunctions are 1. For the disjunction claim, the case a=1 is trivial. The case of a≠1 is also trivial since then 1 [symbol] a. For the conjunction claim, a=1 is again trivial. Suppose a′ is a nonatom. Write a′=b∨c where b, c are nonzero and bc=0. So b [symbol] a and c [symbol] a. Therefore [symbol] ≤bc=0. Now suppose a′ is an atom. Then x [symbol] a if a′ [symbol] x′ if a′≤x by proposition 1.4. So a′≤ [symbol] x. But a′ [symbol] a so [symbol] ≤a′ therefore [symbol] x=a′.

Let a∈ [symbol] , then

$${⋃}_{x ≱ a} = \{ \begin{matrix}0 & a = 0 \\ {a}^{′} & a is an atom \\ 1 & otherwise\end{matrix}$$

$${⋂}_{x ≱ a} x = \{ \begin{matrix}1 & a = 0 \\ 0 & otherwise\end{matrix}$$

If a=0 then the disjunction and the conjunction are empty. If a=1 then all x≠1 satisfy x [symbol] a. Suppose a, a′ are both non-atoms. Then exist c, d s.t. 0<c<a∧0<d<a′. Set x=c∨d. Then x [symbol] a since and x′ [symbol] a, since (c∨d) a=c≠0 and

ac′d′=ac′d+ac′=acd+ad+ac+a=a+c≠0

therefore in this case, the big union is one and the big intersection is zero. If a is an atom, we can write the two equations as

$${⋃}_{x ∈ ℬ} {a}^{′} x$$

$${⋂}_{x ∈ ℬ} {a}^{′} x$$

which, by theorem 1.3, equal a′ and 0, respectively. If a′ is an atom we note that

$${⋃}_{x ≱ a} x = {⋃}_{x ≰ {a}^{′}} x = {⋃}_{x ≰ {a}^{′}} {x}^{′} = {[ {⋂}_{x ≰ {a}^{′}} x ]}^{′} = 1$$

where the last equality is by 4.1, similarly

$${⋂}_{x ≱ a} x = {[ {⋃}_{x ≰ {a}^{′}} x ]}^{′} = 0$$

Let ƒ be a BF and a∈ [symbol] . Then

$${⋃}_{x ≰ a} f ( x ) = \{ \begin{matrix}0 & a = 1 \\ af ( 0 ) ⋃ f ( 1 ) & {a}^{′} is an atom \\ f ( 0 ) ⋃ f ( 1 ) & otherwise\end{matrix}$$

$${⋃}_{x ≰ a} f ( x ) = \{ \begin{matrix}1 & a = 1 \\ f ( 1 ) ( f ( 0 ) ⋃ {a}^{′} ) & {a}^{′} is an atom \\ f ( 0 ) f ( 1 ) & otherwise\end{matrix}$$

$${⋃}_{x ≱ a} f ( x ) = \{ \begin{matrix}0 & a = 0 \\ f ( 0 ) ⋃ {a}^{′} f ( 1 ) & {a}^{′} is an atom \\ f ( 0 ) ⋃ f ( 1 ) & otherwise\end{matrix}$$

$${⋃}_{x ≱ a} f ( x ) = \{ \begin{matrix}1 & a = 0 \\ f ( 0 ) ( f ( 1 ) ⋃ a ) & a is an atom \\ 0 & otherwise\end{matrix}$$

Write ƒ(x)=xƒ(1)∪x′ƒ(0)=(ƒ(1)∪x′)(ƒ(0) ∪x). Then, using formulas above:

$${⋃}_{x ≰ a} f ( x ) = {⋃}_{x ≰ a} xf ( 1 ) ⋃ {⋃}_{x ≰ a} {x}^{′} f ( 0 ) = f ( 1 ) {⋃}_{x ≰ a} x ⋃ f ( 0 ) {⋃}_{x ≰ a} {x}^{′} = f ( 1 ) {⋃}_{x ≰ a} x ⋃ {f ( 0 ) [ {⋂}_{x ≰ a} x ]}^{′} = f ( 1 ) \{ \begin{matrix}0 & a = 1 \\ 1 & a \neq 1\end{matrix} ⋃ f ( 0 ) \cdot \{ \begin{matrix}0 & a = 1 \\ a & {a}^{′} is an atom \\ 1 & otherwise\end{matrix}$$

$$similarly$$

$${⋃}_{x ≰ a} f ( x ) = f ( 1 ) {⋃}_{x ≰ a} x ⋃ {f ( 0 ) [ {⋂}_{x ≰ a} x ]}^{′} = [ f ( 1 ) ⋂ \begin{matrix}0 & a = 0 \\ \{ {a}^{′} & a is an atom ] \\ 1 & otherwise\end{matrix} ⋃ [ f ( 0 ) ⋂ \{ \begin{matrix}0 & a = 0 \\ 1 & otherwise\end{matrix} ]$$

and the intersections are dual, e.g. [symbol] ƒ(x)=[ [symbol] ƒ′(x)]′.

Let a₁, . . . , aₙ be elements of [symbol] , none of which is 0 nor 1, and where [symbol] is atomless, and n>1. Put X={x|(x [symbol] a₁)∧ . . . ∧(x [symbol] aₙ)}. Then

$${⋃}_{x ∈ X} x = 1$$

$$and$$

$${⋂}_{x ∈ X} x = 0$$

$$Write X as X = \{ x \vert ( {a}_{1}^{′} x \neq 0 ) ∧ … ∧ ( {a}_{n}^{′} x \neq 0 ) \} . Let$$

$$Y = \{ x \vert ( {a}_{1}^{′} x \neq 0 ) ∧ … ∧ ( {a}_{n}^{′} x \neq 0 ) ∧ ( {a}_{1}^{′} {x}^{′} \neq 0 ) ∧ … ∧ ( {a}_{n}^{′} {x}^{′} \neq 0 ) \}$$

If we show that Y is nonempty then the lemma is proved because then X contains an element together with its complement, but the nonemptyness of Y follows directly from corollary 2.2.

An interesting property of atomless BA arises from the proof. In any BA, if ƒ(x)=0 then ƒ(x′)≠0 unless ƒ≡0. This is because ƒ(x)∪ƒ(x′)=ƒ(0)∪ƒ(1) for all ƒ, x. However in case of g₁(x)=0, . . . gₙ(x)≠0,in atomless BA, there's always a satisfying x s.t. x′ also satisfies the inequations.

For BFs, g s.t. ƒ(0)ƒ(1)=0 (trivial otherwise) we have

$${⋃}_{x \vert f ( x ) = 0} g ( x ) = g ( f ( 0 ) ) ⋃ g ( {f}^{′} ( 1 ) )$$

$${⋂}_{x \vert f ( x ) = 0} g ( x ) = g ( f ( 0 ) ) ⋂ g ( {f}^{′} ( 1 ) )$$

This is a direct application of proof above.

Now ∪_{x|ƒ(x)≠0}g(x) can easily be evaluated by noting that

$${⋃}_{x \vert f ( x ) \neq 0} g ( x ) = {⋃}_{x \vert x ≱ f ( 0 )} g ( x ) ⋃ {⋃}_{x \vert x ≰ {f}^{′} ( 1 )} g ( x )$$

and the above.

In atomless BA and for BFs, g s.t. ƒ(0)ƒ(1)=0 (otherwise use 4.3) we have

$${⋂}_{x \vert f ( x ) \neq 0} g ( x ) = g ( 0 ) g ( 1 )$$

$${⋂}_{x \vert f ( x ) \neq 0} g ( x ) = ( g ( 1 ) ⋃ {[ {⋃}_{x \vert f ( x ) \neq 0} x ]}^{′} ) ( g ( 0 ) ⋃ {⋂}_{x \vert f ( x ) \neq 0} x )$$

and use the lemma above.

A univariate BFf is called wide if ƒ(0)ƒ(1)=0 and

$$\frac{\partial f}{\partial x} \neq 0 ∧ \frac{\partial f}{\partial x} \neq 1.$$

Note that this means that ƒ has more than one zero and is not identically zero. Clearly we can define “wide wrt x” in case ƒ depends on several variables. Recall that the Boolean derivative is

$$\frac{\partial f}{\partial x} = f ( 0 ) + f ( 1 ) .$$

Let [symbol] be a BA and ƒ a wide BF over it. Then [symbol] /ƒ is the BA whose elements lie in the interval [ƒ(0), ƒ′(1)]. All BA operations are relative to this interval, so x′ is x′ƒ′(1) and xy is xy∪ƒ(0). We also define the epimorphism h_{ƒ}: [symbol] → [symbol] /ƒ by h_{ƒ}(x)=a∨bx.

Let [symbol] be countabe atomless and ƒ a wide BF over it. Then [symbol] is isomorphic to [symbol] /ƒ.

It is easy to see that [symbol] /ƒ is also countable and atomless. But all countable atomless BAs are isomorphic.

Let [symbol] be countabe atomless and ƒ a wide BF over it. The univariate elementary GSBE ƒ(x)=0∧∧ᵢgᵢ(x)≠0 has a solution if ∧ᵢgᵢ(x)+0 has a solution in [symbol] /ƒ.

Let [symbol] be countabe atomless and ƒ a wide BF over it. Let g₁, . . . , gₖ be univariate BFs, none of which is identically zero. Then

$${⋃}_{x \vert f ( x ) = 0 ∧ {∧}_{i} {g}_{i} ( x ) \neq 0} x = {f}^{′} ( 1 )$$

$${⋂}_{x \vert f ( x ) = 0 ∧ {∧}_{i} {g}_{i} ( x ) \neq 0} x = f ( 0 )$$

Consider the expressions

$${⋃}_{x \vert {∧}_{i} {g}_{i} ( {h}_{f} ( x ) ) \neq 0} {h}_{f} ( x )$$

$${⋂}_{x \vert {∧}_{i} {g}_{i} ( {h}_{f} ( x ) ) \neq 0} {h}_{f} ( x )$$

which is the same as considering

$${⋃}_{x ∈ ℬ / f \vert {∧}_{i} {g}_{i} ( x ) \neq 0} x$$

$${⋂}_{x ∈ ℬ / f \vert {∧}_{i} {g}_{i} ( x ) \neq 0} x$$

while the first readily equals 1 by lemma 4.4 and the second equals 0. However the preimage of 1 in [symbol] /ƒ anything greater or equal to ƒ′(1). But obviously

$${⋃}_{x \vert f ( x ) = 0 ∧ {∧}_{i} {g}_{i} ( x ) \neq 0} x \leq {f}^{′} ( 1 )$$

therefore equality follows. Similarly the preimage of 0 is anything less than ƒ(0), but all x's satisfying ƒ(x)=0 are at least ƒ(0), so the second equality follows.

In case that ƒ is not wide, the result can immediately be calculated as the union is either empty or contains one element.

Let [symbol] be countabe atomless and ƒ a wide BF over it. Let g₁, . . . , gₖ be univariate BFs, none of which is identically zero, and h some arbitrary BF. Then

$${⋃}_{x \vert f ( x ) = 0 ∧ {∧}_{i} {g}_{i} ( x ) \neq 0} h ( x ) = h ( 1 ) {f}^{′} ( 1 ) ⋃ h ( 0 ) {f}^{′} ( 0 )$$

Simply

$${⋃}_{x \vert f ( x ) = 0 ∧ {∧}_{i} {g}_{i} ( x ) \neq 0} h ( x ) = h ( 1 ) {⋃}_{x \vert f ( x ) = 0 ∧ {Λ}_{i} {g}_{i} ( x ) \neq 0} x ⋃ {h ( 0 ) [ {⋂}_{x \vert f ( x ) = 0 ∧ {∧}_{i} {g}_{i} ( x ) \neq 0} x ]}^{′}$$

and using the previous corollary.

### Definability of Models in LTA

Suppose the LTA of some logic [symbol] make an atomless BA. Consider a formula with a single free variable φ(x) in the BA theory of that LTA. Then φ defines a set of formulas in [symbol] . In other words, it defines a set of sets of models. If we want to ask whether a model is in that set of sets, we can take the union of those sets. The previous results allow us to do so. The BA is atomless so we can assume that φ is quantifier free, and further is given in DNF. The desired set of models

{M=x|x∈ [symbol] ∧φ(x)}

can be computed using

$${⋃}_{x \vert f ( x ) = 0 ∧ {∧}_{i} {g}_{i} ( x ) \neq 0} x = {f}^{′} ( 1 )$$

We conclude that the negative literals of each DNF clause do not contribute to this set of models. Remarkebly, if φ contains only negative statements, namely of the form “x does not entail y” or “x is not entailed from y”, we obtain

$${⋃}_{{∧}_{i} {g}_{i} ( x ) \neq 0} x = 1$$

which means that for every model there is a formula x satisfying φ(x).

In the treatment of GSSOTC later on, a model is going to be a program, and a formula will be a specification. If GSSOTC speaks of its own BA, and has uninterpreted constant symbols of that type, then any program will admit this interpretation as long as there are no positive constraints, and even if there are such, negative constraints will not matter. This is very counterintuitive. Further, this union is only about the “positive part of the positive part”, namely ƒ(1) and not ƒ(0). Therefore ƒ may take the form ƒ=ax. So any way of expressing a set of programs using interpretation of constant symbols in GSSOTC, can be reduced to merely a single atomic formula of the form x≤a.

### 11—MONADIC ALGEBRAS

Monadic algebras, which are Boolean Algebras extended with an operator ∃ called a quantifier, were studied extensively Jonsson, Tarski, Halmos, and others. Given any such operator that satisfies the axioms of monadic algebras, a necessary and sufficient condition for the existence of a solution for f(x, ∃x)=0, where f is a Boolean function over a monadic algebra, such as ax∃x+bx [symbol] ∃x+c(∃x) [symbol] x+d( [symbol] x)( [symbol] ∃x)=0 is (∃d)(ac∨∀a)=0, where ∀= [symbol] ∃ [symbol] .

### 12—LOGICAL LANGUAGES THAT REFER TO TRUTH

Designing logical languages with the ability to refer to the truth of their own sentences is a long journey in the field of mathematical and philosophical logic. The results in this area are mainly negative: in a certain yet very wide sense, it is impossible to include statements about truth in a language, about statements in the same language, while keeping the language consistent. The inclusion of such truth references allows languages to express paradoxes. Maybe the most well-known result of this nature is Tarski's Undefinability of Truth.

In this age of computing, such an inability becomes a practical limitation. One formal language cannot refer to whether another statement in that language is true, or whether one sentence entails the other, as well as similar logical questions that come down to speaking about truth. Many remedies were proposed in the literature (e.g., paraconsistent and many-valued logics), but they are all of the nature of allowing languages to contain paradoxes, and by that rendering the languages to be so-called “nonclassical logics”. In those languages, it is therefore no longer the case that every precise statement is either true or false (in a given model if such a setting even has a model theory) in the classical sense.

It is widely believed, albeit not proved, that classical logics cannot have a truth predicate. This application presents a method to extend virtually any language with the ability to refer to the truth of other sentences, as well as to quantify over its own sentences, while maintaining the original language (here the “base logic”) classical and consistent. Even more surprisingly, the construction typically preserves decidability. If the base logic is decidable, so is the extended language. This avoids Tarski's impossibility result by not allowing a syntactic representation of sentences as Tarski requires, but treating them purely semantically, and further allowing only certain operations over them.

Specifically, consider the Lindenbaum-Tarski Algebra (LTA) of some language L. It is the Boolean Algebra (BA) generated by sentences (or formulas) in L, up to logical equivalence. Therefore, it is assumed that L makes a Boolean Algebra. In some embodiments, this Boolean Algebra is further assumed to be atomless. In particular, virtually any language over an infinite signature that makes a Boolean Algebra, makes an atomless one.

The method is as follows: consider the first-order theory of Boolean Algebra interpreted in that Boolean Algebra and extended with a respective constant symbol corresponding to each Boolean Algebra element. In other words, the constants are nothing but formulas in the base logic. The resulting language is trivially consistent and classical, just like the first order theory of any Boolean Algebra. Referring to unsatisfiability and tautology (being the above truth predicates) are simply asking whether a constant or a variable equals zero or one. Further it is possible to quantify over formulas as usual quantification of Boolean Algebra elements.

So far, this creates one language that may speak of another language, but still not about itself. Languages speaking about truth of sentences in other languages is the only known remedy, and it is the widely used common practice for defining and referring to truth (albeit typically not via a Boolean Algebra). However, there are additional steps to elevate this Boolean Algebra construction into a language that speaks about itself.

For that, the first-order theory of the Boolean Algebra can be the LTA of L and have itself an LTA that is elementarily equivalent to the Boolean Algebra of L. A simple case is when the Boolean Algebra is atomless, because all atomless Boolean Algebras are elementarily equivalent (and so are all infinite atomic Boolean Algebras), as demonstrated by Tarski. For that, simply enhance the extended language with infinitely many additional uninterpreted constant, relation, or function symbols. There are many ways, artificial or not, to do so. In an even more extended language (e.g., used for software specification), the atomless property may be obtained by allowing infinitely many input and output streams.

This methodology creates a logic that speaks about the truth of its own sentences as well as quantifying over its own sentences. Further, there are infinitely many such logics, one per choice of base logic. Constants, however, need to be from the extended language. This is described in the construction below.

The section below gives a more precise description of the construction. This considers extending many languages at once, and it is a feature of the construction to allow languages to coexist in a novel method of combining logics.

### 13—THE LANGUAGE NSO

Fix a set of languages (the “base logics”, which need not be related in any way) in which their formulas make a Boolean Algebra. (The formulas are considered up to logical equivalence, in which case it's called the LTA (Lindenbaum-Tarski Algebra) of the language, or by any other equivalence relation of choice.) Then it is possible to consider the many-sorted Boolean Algebra theory of those Boolean Algebras. Constants in that language are formulas in the base logics. Quantification takes the same semantics of quantification over arbitrary Boolean Algebra elements. If the base logics make an atomless Boolean Algebra, then the extended language has decidable satisfiability if and only if the base logics have decidable satisfiability. Otherwise, decidable model counting is required. More precisely, when seen as a Boolean Algebra, it is necessary to know whether an element is a disjunction of at least n distinct atoms.

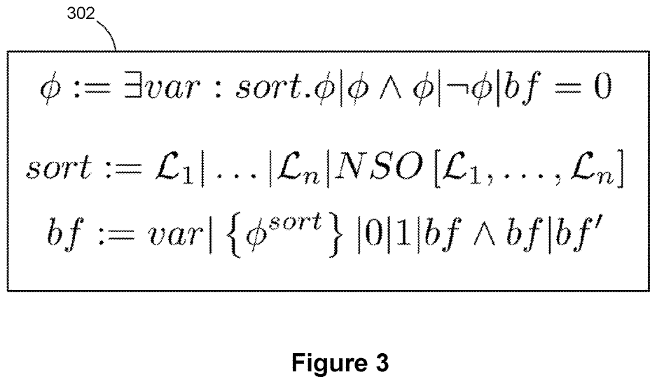

Denote the extended language by NSO[L₁, . . . , Lₙ], where NSO stands for Nullary Second Order (though not under the usual semantics of nullary relations). It is possible to obtain a language that quantifies over its own formulas (quotiented by logical equivalence) as follows. First, NSO[L₁, . . . , Lₙ] can already quantify over formulas in L₁, . . . , Lₙ in the standard fashion of quantification in a Boolean Algebra. In this setting, each NSO formula is either true or false, because it is interpreted in a fixed model (being the Boolean Algebra that is the LTA of the base logic), and therefore makes a small (only two-element) Boolean Algebra. This is typically still far from being elementarily equivalent to the Boolean Algebra of the base logics. To obtain a richer Boolean Algebra from formulas in NSO[L₁, . . . , Lₙ], it can be enhanced with infinitely many relation and/or function symbols, possibly in a decidability preserving fashion (e.g., in the ways mentioned above). Assume NSO[L₁, . . . , Lₙ] is properly extended such that it now makes an atomless Boolean Algebra (and other kinds of Boolean Algebras are treated similarly). Constants now may be formulas in NSO[L₁, . . . , Lₙ] appearing inside curly brackets in order to avoid syntactic ambiguity. Handling of quantifiers for the sake of a decision procedure can be done by means of the above quantifier elimination decision methods described in sections 5 and 6 above. The basic syntax of NSO[L₁, . . . , Lₙ] (before being extended in any way that makes it an atomless Boolean Algebra) can be expressed as a set of three BNF productions, as shown in the box 302 in FIG. 3.

In these productions, [symbol] means any formula in the language L. Each bf may only contain variables and constants from the same sort. The deep-most level of formulas in [nested] curly brackets will be either a formula in L₁, . . . , Lₙ or a formula in the language of Boolean Algebra where the only constants appearing in the formula are either 0 or 1. It is then interpreted as a formula over arbitrary atomless Boolean Algebras because they are all elementarily equivalent.

Consider the LTA of sentences in some logical language. This LTA is a BA that comes with the theory of BA. The sentence ∀x∃y·xy′=0 in the language of BA interpreted in some LTA, would mean “for all sentence x exists a sentence y s.t. x entails y”. So we can immediately see how the BA theory of an LTA is a theory that speaks about sentences of some language, where those sentences are not accessible syntactically, but abstracted to merely BA elements.

Countable atomless (CA) BAs arise naturally in logical languages. cf. remark 1.4 and recall that almost all languages of interest are countable. All CA BAs are therefore isomorphic, and moreover, all atomless BAs are elementarily equivalent.

So, if we manage to take a language that makes a CA BA (or at least atomless BA), and we're able to make the language of BA interpreted in that LTA a CA BA as well, then we have a language that refers to its own sentences, their Boolean combinations, logical equivalence, and truth.

This, in sharp contrast to the setting of Tarski's undefinability of truth: that impossibility result assumes that we have direct access to the syntax of the sentences, represented, e.g., by a Godel number. However in our setting sentences are abstracted, so much so, that they make merely BA elements.

How can we have a theory of BA in which its own LTA makes an atomless BA? One trivial, yet not so useful example, is to take all formulas with unbounded number of free variables. A more useful approach is to add infinitely many uninterpreted constants. Another approach would be to incorporate in the signature infinitely many homomorphism and hemimorphism symbols. It is even easier if the language is extended even further to have a time dimension.

### 14—EXAMPLE OF SOFTWARE UPDATE

Suppose a software system has an auto-update feature. It downloads an update, performs certain checks on the new code (the update), and if the checks pass, installs it. It is useful to have the current software and the update written in the same language. Otherwise there is a need for many languages (one for each update). If the checks are of the form of logical implication (e.g., “if the new code implies that private data is sent over the network then reject the update”), then there is a language that speaks about consistency of Boolean combination of sentences in the same language. No previously existing language can support that. But with NSO, it takes the form uc′=0 where u is the update and c is a condition, and the formula is true if and only if u implies c.

### 15—EXTENDING LANGUAGES WITH RECURRENCE RELATIONS

In fields that relate to computational logic, such as automated reasoning, automated theorem proving, knowledge representation and reasoning, and formal verification, is it of utmost interest to devise richer formal languages that are still decidable. In particular, it is valuable to have an algorithm that allows determining whether a statement in such languages contains a contradiction. Disclosed techniques show how to enrich a certain class of languages with Recurrence Relations (RR). The enrichment includes forms of recursion and fixed-point operators, while maintaining the algorithmic properties of the original languages, by showing how to convert a statement in the extended language into one in the original language.

The construction here uses the notion of a “weakly w-categorical theory.” In mathematical logic, a “theory” is a set of sentences in a formal language. In many deductive systems there is a set of “axioms” for the theory and other sentences are derived from the axioms by a set of inference rules. A first-order theory is a set of first-order sentences recursively obtained by the inference rules from the set of axioms.

An ω-categorical theory is a first order theory in which all of its countable models are isomorphic. The Ryll-Nardzewski theorem says that this definition is equivalent to another definition. That is, an ω-categorical theory is one in which, up to logical equivalence, there are only finitely many formulas having a fixed number of free variables. This gives rise to defining weakly ω-categorical theories. Weakly ω-categorical theories are those theories where the following set of formulas is finite. The formulas to count are those having a fixed number of variables where all of the constants appearing in them are taken from a fixed finite subset of all constants in the language (up to logical equivalence). Further, even when a theory is not weakly ω-categorical, the language may posses a computable function that reduces each sentence in the language to an equisatisfiable one in some fragment of the original language that is weakly ω-categorical. Note that it does not matter whether the language is interpreted in a certain model.

Any W-categorical theory is a weakly ω-categorical theory, but not vice versa. For example, theories of atomless Boolean Algebras (thanks to their quantifier elimination properties described above), with atomic formulas being Boolean Functions and not merely Simple Boolean Functions, are weakly ω-categorical but not ω-categorical, because the constants may be interpreted in infinitely many ways. If atomic formulas were limited to Simple Boolean Formulas only, the theory would be ω-categorical (and there is no further distinction regarding which atomless Boolean Algebra is chosen since they are all elementarily equivalent according to Tarski).

It is easy to see that the theory of atomless BA and of fixed finite BA, are both weakly ω-categorical (cf. remark 1.3). In what follows we shall deal only with those BA theories. However the construction in this section can be carried out into any weakly ω-categorical theory. Yet in BA we have an additional aspect not covered by this notion: the above principle holds not only for formulas but also for terms. Specifically, there are only finitely many BFs with prescribed finite set of constants and variables.

The ceiling operator is a function defined by

$$⌈ x ⌉ = \{ \begin{matrix}0 & x = 0 \\ 1 & x \neq 0\end{matrix}$$

A Conditional Boolean Function (CBF) is a finite combination of constants and variables by means of Boolean operations and the ceiling operator.

Note that under the ceiling operator we can have a whole expression, namely a whole CBF. So for example

┌x+y┐xy

is a CBF which is equivalent to

$$\{ \begin{matrix}0 & x = y \\ xy & x \neq y\end{matrix}$$

An equivalent definition of CBF is a function of the form

CBF:=BF|if φ then CBF else CBF

where φ is any formula in the language of BA. In case of atomless or finite BAs, yet another equivalent definition is obtained by allowing the ceiling operator to accept a formula φ, returning 0 or 1 as whether the formula is false or true.

We are now ready to define a formula in the language of BA enhanced with recurrence relations. It is a list of the form

$${f}_{0}^{1} ( X ) = {F}_{0}^{1} ( X )$$

$${f}_{n}^{1} ( X ) = {F}^{1} ( {f}_{n - 1}^{{k}_{1}^{1}} ( X ) , {f}_{n - 2}^{{k}_{2}^{1}} ( X ) , … , {ϕ}_{n}^{{m}_{1}^{1}} ( X ) , {ϕ}_{n - 1}^{{m}_{2}^{1}} ( X ) , … )$$

$${f}_{n}^{2} ( X ) = {F}^{2} ( {f}_{n - 1}^{{k}_{1}^{2}} ( X ) , {f}_{n - 2}^{{k}_{2}^{2}} ( X ) , … , {ϕ}_{n}^{{m}_{1}^{2}} ( X ) , {ϕ}_{n - 1}^{{m}_{2}^{2}} ( X ) , … )$$

$$…$$

$${ϕ}_{n}^{1} ( X ) = {Φ}^{1} ( {f}_{n - 1}^{{p}_{1}^{1}} ( X ) , {f}_{n - 2}^{{p}_{2}^{1}} ( X ) , … , {ϕ}_{n}^{{q}_{1}^{1}} ( X ) , {ϕ}_{n - 1}^{{q}_{2}^{1}} ( X ) , … )$$

$$…$$

$$ψ ( {f}^{1} , {f}^{2} , … , {ϕ}^{1} , {ϕ}^{2} , … )$$

This messy definition is actually very simple. We simply define formulas (the φ's) and CBFs (the ƒ's) by means of recurrence relations, which may mutually depend on each other. ψ is the “main” formula. For example:

$${f}_{0} ( x , y ) = {xy}^{′}$$

$${f}_{n} ( x , y ) = ⌈ x = y ⌉ x + y {f}_{n - 1} ( y , x ) {ϕ}_{1} ( x , y ) = x$$

$${ϕ}_{2} ( x , y ) = y$$

$${ϕ}_{n} ( x , y ) = ∃ z \cdot {ψ}_{n - 1} ( x , z ) ∧ {ϕ}_{n - 1} ( z , y ) ∧ {ϕ}_{n - 2} ( z , x )$$

$$∀ x ∃ y ∃ z . f ( x , y ) = 0 ∧ ϕ ( y , z )$$

Here ƒ(x, y) is understood naturally as expected: it is the limit that ƒₙ converges into. Similarly for φ. Clearly it does not always converge, but it is easy to pin down all cases, as follows:
(1) The dependency of functions, formulas, and their initial conditions, has to be well founded. So ƒₙ can't depend on gₙ (or φₙ) in case that gₙ (or φₙ) depend on ƒₙ. However ƒₙ can depend on gₙ₋₁ and so on. This comes down to verifying that a certain directed graph is acyclic.
(2) The initial conditions should also be sufficient to allow calculating ƒₙ, φₙ for any given n.
(3) And most importantly: while calculating ƒ₁, ƒ₂, ƒ₃, . . . and φ₁, φ₂, φ₃, . . . we are guaranteed to find a loop, namely for some n≠k, φₙ≡φₖ (logical equivalence) and similarly for ƒ. if n=k−1 then it is a fixed point and the result is well-defined. Otherwise we can proceed in virtually any fashion: either we return 0 or ⊥, or the first recurring expression, or we enhance the language to incorporate “fallbacks” that return a default answer in case of no fixed point.
   This, together with the properties of the language, should be sufficient to show that BA with recurrence relations can be written in an equivalent form in pure BA without recurrence relations.

Multi-indices recurrence relations are supported in the same manner, namely recurrence relations of the form

ƒ_{n,k}=F(ƒ_{n,k-1},ƒ_{n-1,k}) . . . )

Clearly the same construction can be carried out while involving higher-order BFs.

### 16—GSSOTC: A NOVEL TEMPORAL LOGIC

In fields that relate to computational logic, such as automated reasoning, automated theorem proving, knowledge representation and reasoning, and formal verification, is it very useful to devise richer formal languages that are still decidable. In particular, it is valuable to have an algorithm that allows determining whether a statement in such languages contains a contradiction. In many logical languages it is important to have a temporal aspect. For example, in software and process specification languages, it is important to be able to express statements of the form “first do this and then do that.” Moreover, in many cases it is very important to distinguish between inputs and outputs.

Many temporal logics exist from the early days of computer science and computational logic. One of their main limitations is that they commonly become undecidable when the number of possible states is not finite or not bounded. In addition, many temporal logics have a limited ability to distinguish between inputs and outputs, if at all. Overcoming the decidability issue is a major active area of research, sometimes referred to as temporal logics over infinite data values. The data elements are commonly equipped with only very simple operations, typically limited to checking for equality. Further, these logics and other similar machineries are typically not closed under Boolean combinations.

Disclosed here is a new, decidable, family of temporal logics over infinite data values, where those values come with theories much richer than merely equality. And some embodiments are equipped with the theory of Boolean Algebras. Further this language enjoys the distinctive ability to verify statements of the form “for all inputs there exist a well-defined output.” Moreover, this logic extends beyond merely a temporal logic. It is a highly expressive language and is also decidable.

In what follows, L denotes an arbitrary logic (potentially with additional conditions specified), and D denotes its domain of discourse (i.e., D is the set of elements over which the first-order quantifiers range). For each formula there may be many interpretations, each with a different domain D.

Given a language L, it can be extended in the following way into the language denoted by GS[Z], where GS stands for “Guarded Successor.” This will further be extended to the language GSSOTC[L], standing for “Guarded Successor Second Order Time Compatible.” Decision procedures are then described for that language.

We present GS (Guarded Successor), a novel decidable temporal logic with several unique distinctive features. Among those, it allows infinitely many data values that come not only with equality but with a somehow rich theory too: the first-order theory of atomless Boolean algebras. The language also distinguishes between inputs and outputs, and has a decision procedure for determining whether for all inputs exist outputs, at each point of time. Moreover, and maybe most surprisingly, the data values can be nothing but sentences in GS itself. We also present a non-temporal fragment called NSO (Nullary Second Order) that enjoys merely this last property. These results are crucial necessary ingredients in any meaningful design of safe AI. Finally, all those results are obtained from a novel treatment of the first-order theory of atomless Boolean algebras.

Traditional computation is temporal manipulation of bits. Bits, are the elements of the smallest possible Boolean algebra. The construction here can be seen as a generalization of this into working over certain infinite Boolean algebras. Decidability of a specification language in this model is of course much less trivial. Further, we will show how this generalization can support some very surprising abilities.

In the following, GS (Guarded Successor) is introduced, an innovative and decidable temporal logic that offers several distinctive features. First, it accommodates infinitely many data values, enhanced by a complex theory: the first-order theory of atomless Boolean algebras. Second, the language differentiates between input and output variables, and allows a decision procedure to prove that for all inputs there exist outputs, at each point in time. Third, and perhaps most surprisingly, the data values can be sentences in GS itself. The language is closed under Boolean combinations and allows quantification over both data values and time points. Its decision procedure is of a uniquely simplistic and elegant nature, and differs very much from other common decision procedures. It relies on the ability to enhance certain languages with recurrence relations (a form of fixed-point operators), in particular an extension of the first order theory of atomless Boolean algebras.

We also present NSO (Nullary Second Order logic, a name that was selected during the first incarnations of the idea and perhaps has to be reconsidered), a non-temporal fragment that maintains the above third property. All of these findings stem from a new approach to the first-order theory of atomless Boolean algebras. These results are essential for designing safe AI systems.

For ease of understanding we will first introduce the non-temporal NSO logic and afterwards we will introduce GS, which can be seen as a temporal extension of NSO. All nontrivial proofs not appearing in the main text, appear in the appendix.

Ongoing implementation of the languages described in this paper appears at the repository https://github.com/idni/tau-lang.

The goal of NSO is to have a language that can speak about its own sentences in a consistent and decidable way. Tarski's Undefinability of Truth has shown that this is impossible under a certain broad setting. The key of NSO is to abstract sentences, so much so, that they make merely Boolean algebra (BA) elements. In particular, there is no access to the syntax of the sentences (in contrast to Tarski's setting which relies on Gödel numbers), and logically equivalent sentences are identified.

Any classical logic closed under Boolean combinations makes a BA called the Lindenbaum Tarski Algebra (LTA) of that logic. Recall that this is only up to logical equivalence. Now observe two important points: 1. Any such logic that has an infinite signature (whether constant, relation, or function symbols), makes an atomless BA. 2. All countable atomless BAs are isomorphic (which is a well known theorem), and moreover, all atomless BAs are elementarily equivalent, as proved by Tarski. Clearly all sentences in languages of interest are finite strings over a finite alphabet, hence countable. The countable atomless BA is therefore the LTA of major logics of interest.

When we say “the theory of BA interpreted in a fixed BA [symbol] ” we mean not only the first order theory of BA interpreted in [symbol] (recall that an interpretation is a mapping taking symbols from the signature to actual objects in a structure), but we also mean that its signature is equipped with constants that are interpreted in each element of [symbol] , so each element has a unique constant assigned to it. We will refer to those constants as the interpreted constants.

Fix a language [symbol] that its LTA makes an atomless BA. Let NSO[ [symbol] ] be the first-order theory of BA interpreted in that LTA, so each sentence in [symbol] is a constant symbol in NSO[ [symbol] ]. So far, NSO[ [symbol] ] is a language that speaks about [symbol] , but still not about itself. To this end, first we make the LTA of NSO[ [symbol] ] be an atomless BA as well (as currently it is only the two-element BA, as any logic that is interpreted in a fixed structure). This can be done by adding infinitely many uninterpreted constant symbols (the uninterpreted constants), or any other such trick. Then, the interpreted constants are extended to include sentences in NSO[ [symbol] ] (this is well-founded by introducing curly brackets as below). Since both [symbol] and NSO[ [symbol] ] make an atomless BA, they are elementarily equivalent under the signature of BA. By that we can make NSO[ [symbol] ] speak (including quantify) over its own sentences. Further, NSO[ [symbol] ] is decidable if [symbol] is decidable.

### 17—THE LANGUAGE GS

As an intuitive starting point, any formula with two free variables, in any logic, can be seen as defining a set of sequences: we say that a sequence s models φ(x, y) if any two consecutive elements sᵢ₋₁, sᵢ in the sequence satisfy φ(sᵢ₋₁, sᵢ) (we can interpret φ in a fixed model, or one may appeal to any suitable notion of satisfiability). We then write s [symbol] φ(x, y). Now consider the class of logics having the following property: fix a finite set of constant and variable symbols. Then the set of formulas making use only of those constant and free variable symbols (we allow, and require, arbitrarily many quantified variables), up to logical equivalence, is finite. Here, the most relevant such logic is the theory of atomless BA (whether or not interpreted in a fixed BA, and when it does, it is equipped with infinitely many interpreted constants as above, and this is the nontrivial case).

Denote by |s| the length of s. Given φ(x, y), consider the following process: ask whether exists s s.t. |s|=2 and s [symbol] φ, then whether exists s s.t.|s|=3 and s [symbol] φ, and so on. This series of questions may take the form of a recurrence relation φₙ(x):=∃y·φₙ₋₁(y)∧φ(x, y) with base-case φ₂(x):=∃y·φ(x, y) (though our preferred form will be slightly different). Then φₙ(x) means “exists a sequence of length n starting with x”, and then to get a final answer (per each n) we of course need to consider ∃x·φₙ(x). Due to the finiteness property above, this series of questions is going to loop (i.e. at one point, a logically equivalent formula will occur), and even reach a fixed point due to the monotonic nature of the setting. We obtain a result of the form: “if a sequence of length N exists, then a sequence of any larger length exists”. It is easy to see that this implies the existence of an infinite sequence as well.

For now we mention only two additional points, which are apparently unique to this language in the landscape of decidable temporal logics:
1. Seen as a program specification language, those sequences are actually outputs or states, however we′d like to support inputs as well. This means that we′d like to prove that for each input, at each point of time, exists an output, that does not depend on future inputs (time-compatible). So we can deal with formulas of the form φ(xₙ, xₙ₋₁, yₙ, yₙ₋₁) where xₙ, xₙ₋₁ are the current and previous inputs, respectively, and similarly for the outputs yₙ, yₙ₋₁. Observe the bounded lookback in this formula, and observe that n can be seen as a free variable of sort [symbol] which is implicitly quantified universally. The quantifier pattern for the inputs and outputs would look like ∀x₁∃y₁∀x₂∃y₂ . . . . It is easy to express it as a recurrence relation similar to the above, and again use the finiteness property as above.
2. Allowing GS to operate over the LTA of its own sentences, in the fashion of NSO, so φ is in the language of atomless BA, gives us a software specification language where inputs and outputs may be sentences in this very same language. This allows, for the first time, support implementations of the form: “reject a software update if it doesn't satisfy certain desired properties” where the currently running program is written in the same language as the update, as well as those “desired properties”. It is therefore a crucial ingredient in AI safety. Fortunately, even decidability is preserved.

### NSO: Nullary Second Order Logic

Building on what we said above, we shall not merely present a language, but a language-extension mechanism, although this extension is not in the standard sense, namely formulas in the base language are not, as for themselves, formulas in the extended language, but constant symbols in it, as we shall see. This extension preserves decidability, let alone consistency. We further consider extending many languages at once, and it is indeed yet another feature of our construction to allow languages to co-exist in one unified language, albeit, of course, the interaction between those languages is very limited. Referring to many BAs at once is easily done by considering the many-sorted theory of BA, alternatively the product algebra.

Fix arbitrary languages (the base logics) in which their formulas (or sentences), up to logical equivalence, make a BA. Then we can consider the many-sorted BA theory interpreted in those BAs. Constants in that language are formulas in the base logics. Quantification takes the same semantics of quantification over arbitrary BA elements. If the base logics make an atomless BA, then the extended language has decidable satisfiability if the base logics have. Otherwise decidable model counting is required, or more precisely, when seen as a BA, to tell whether an element is a disjunction of at least n distinct atoms.

Denote the extended language by NSO[ [symbol] ₁, . . . , [symbol] ₙ]. We show that NSO[ [symbol] ₁, . . . , [symbol] ₙ] can have itself as a base-logic. So far, each NSO formula is either true or false, because it is interpreted in a fixed model (being the BA which is the LTA of the base logic), and therefore makes a small BA (only two elements). To obtain an atomless BA from formulas in NSO[ [symbol] ₁, . . . , [symbol] ₙ] we can simply enhance it with infinitely many uninterpreted constant symbols. After doing so, we now let interpreted constants to be formulas in NSO[ [symbol] ₁, . . . , [symbol] ₙ] appearing inside curly brackets (in order to avoid syntactic ambiguity), and handling of quantifiers for the sake of a decision procedure can be done by means of the atomless BA quantifier elimination algorithm. The basic syntax of NSO[ [symbol] ₁, . . . , [symbol] ₙ] is therefore

φ:=∃var:sort.φ|φ∧φ| [symbol] φ|bf=0

sort:= [symbol] ₁| . . . | [symbol] ₙ|NSO[ [symbol] ₁, . . . , [symbol] ₙ]

bf:=var|{φ^{sort}}|const|0|1|bf [symbol] bf|bf′

where [symbol] means any formula in the language [symbol] . Clearly, each bf may only contain variables and constants from the same sort. const refers to an uninterpreted constant. The deepmost level of formulas in [nested] curly brackets will be either a formula in [symbol] ₁, . . . , [symbol] ₙ or a formula in the language of BA in which the only constants appearing in it are 0,1. It is then interpreted as a formula over arbitrary atomless BA since they're all elementarily equivalent. It is easy to see that going inductively over the depth of curly brackets, gives a decision procedure as well as semantics to this language.

### 18—THE LANGUAGE GSSOTC

We devise a new, decidable, family of temporal logics over infinite data values, where those values come with theories much richer than merely equality, in particular with the theory of atomless Boolean Algebras (as well as fixed finite ones though such a case does not amount to a significant novelty). Further, this language enjoys the distinctive ability to verify statements of the form “at each point of time, for all inputs exist a well-defined output/state, possibly depending on the previous output/state”. It also presents a new kind of decision procedure, unrelated to automata, tableaux, or to any other decision method known to the inventor.

To describe the language in simple intuitive terms: fix an atomless BA and consider the theory of BA interpreted in this structure (with interpreted constants as above so the LTA of this logic is the countable atomless BA). Consider formulas with free variables xₙ₋ₖ, . . . , xₙ, yₙ₋ₖ, . . . , yₙ where the x's are understood as inputs and the y's are understood as outputs, and n is any time point (so it can be seen as a free variable of sort [symbol] ). So it describes connection between current and previous inputs and outputs at each point of time. This is basically almost the full language.

This technique works for any weakly ω-categorical language, as long as it supports conjunction and quantification. However in the atomless BA case we get the unique property of a language that can speak of its own sentences, in the spirit of NSO.

### Time-Compatible Structures

A sequence of elements from some domain [symbol] can be seen as a function [symbol] → [symbol] . A function between sequences is therefore of type ( [symbol] → [symbol] )→( [symbol] → [symbol] ). As customary in many texts, [k] will denote the set {1, . . . , k}.

A function ƒ:( [symbol] → [symbol] )→( [symbol] → [symbol] ) between sequences is prefix-preserving (alternatively time-compatible, TC) if for all sequences p, s, if p is a strict prefix of s, then ƒ(p) is a strict prefix ƒ(s). We extend this notion also for ƒ:([n]→ [symbol] )→([n]→ [symbol] ).

A Time-Compatible (TC) Structure of length N∈ [symbol] ∪{∞} is a domain D with prefix-preserving functions [symbol] ^{N}→ [symbol] ^{N}.

It should be clear that any computer program is a TC structure: at each point of time it takes an input and outputs an output, while the output may depend only on past and present inputs and outputs, not future ones. This is why we refer to prefix-preservation as TC.

Due to the “lookback” ability, namely the dependence on previous inputs and outputs, we don't need to refer to the concept of state, as it is subsumed by the concept of output.

In what follows we will deal only with infinite-time TC structures (so N=∞ in the above definition) unless stated otherwise.

We will eventually be interested with functions from tuples of sequences to tuples of sequences (all tuples of fixed finite size, but the input tuple may be of different size than of the output tuple). All definitions and results should apply mutatis-mutandis.

The setting can easily be extended to trees rather sequences. It is done by allowing more than one successor relation, and the same methods apply.

A TC function has bounded lookback (BL) of length k∈ [symbol] (or simply BL[k]) if exists m≥k (the recurrence point), s.t. for each n>m, the output sequence at point n depends only on the input and output sequences at points n−1, . . . , n−k, as well as the input at point n.

If ƒ is BL[k] then it can be expressed as a pair of functions, one of type [symbol] ^{2k+1}→ [symbol] and another of type [symbol] ^{m}→ [symbol] ^{m} which is required to be TC.

By definition of BL functions, we can write ƒ as a recurrence relation

[ƒ(x)]ₙ=g(xₙ,xₙ₋₁, . . . ,xₙ₋ₖ,[ƒ(x)]ₙ₋₁, . . . ,[ƒ(x)]ₙ₋ₖ)

(where x is the input sequence) with initial conditions of the form [ƒ(x)] i= . . . for 1≤i≤k. This g is of type [symbol] ^{2k+1}→ [symbol] and together with the initial conditions (which specify the behavior up until the recurrence point), fully encodes ƒ.

Given a pair of functions, one of type [symbol] ^{2k+1}→ [symbol] , and another, which is TC, of type [symbol] ^{m}→ [symbol] ^{m}, we can uniquely assign to it a function of BL[k].

### Bounded Lookback and Recurrence Relations

Any formula (in virtually any logic) with 2k+2 free variables defines a [possibly empty] set of BL[k] functions.

Assume k=1 for simplicity. Consider φ(xₙ₋₁, xₙ, yₙ₋₁, yₙ). We understand φ as defining a relation between inputs and outputs at current time (xₙ, yₙ respectively) and in the previous time xₙ₋₁, yₙ₋₁. Intuitively, it defines at least one BL[k] function if the infinitary expression

$$∀ {x}_{1} ∃ {y}_{1} ∀ {x}_{2} ∃ {y}_{2} … {∧}_{n = 2}^{∞} ϕ ( {x}_{n - 1} , {x}_{n} , {y}_{n - 1} , {y}_{n} )$$

is satisfiable, alternatively if it is true in a model of choice. This infinitary expression can be given a concrete meaning by considering the first order theory containing all formulas of the form

$$∀ {x}_{1} ∃ {y}_{1} … ∀ {x}_{N} ∃ {y}_{N} \cdot {∧}_{n = 2}^{∞} ϕ ( {x}_{n - 1} , {x}_{n} , {y}_{n - 1} , {y}_{n} )$$

### for all N.

Note that in the infinitary expression obtained in the proof, quantifiers can be pushed inside. This is a property of being TC, and this ability is one crucial point in the upcoming construction. Also note that skolemization of this expression will yield something similar to the type above.

The initial conditions are not expressed in the latter corollary. But the corollary still holds. It defines a set of functions that include functions per each possible initial conditions. This is not an inherent limitation. We used this form only for simplicity at this stage.

Fix a lookback parameter k≥0.Xⱼ will denote a tuple of variables of lookback k, so it's a tuple of k+1 variables of the form xⱼ₋ₖ, xⱼ₋ₖ₊₁, . . . , xⱼ. We assume that the first time coordinate is 0.

Given formula φ (in virtually any logic) with 2k+2 free variables xₙ₋ₖ, . . . , xₙ, yₙ₋ₖ, . . . , yₙ, define a recurrence relation φₙ by φₙ₊₁(Xₖ, Yₖ):=φ(Xₖ, Yₖ)∧∀x_{K+1}∃yₖ₊₁·φₙ(Xₖ₊₁, Yₖ₊₁) with base case φ₁:=φ(Xₖ, Yₖ).

Observe that φₙ(Xₖ, Yₖ) actually says that exists a BL [k] function between sequences of length n+k, where the k initial positions in the sequences are left as free variables.

Note that φₙ has a form of monotonicity wrt n: if exists a TC function between sequences of length n+1, and the function satisfies φ, then clearly exist such a function for sequences of length n.

Clearly, if ∀x₀∃y₀ . . . ∀xₖ∃yₖ·φₙ(Xₖ, Yₖ) for all n, then φ defines a nonempty set of functions in the spirit of corollary 29. The crux of our construction is the observation that if the underlying logic is weakly ω-categorical, then there are only finitely many φₙ's up to logical equivalence, hence decidability and decision procedure are immediate.

### Guarded Successor

Observe that a formula of the form φ(Xₖ, Yₖ) can be given a direct BL[k] semantics also by adding a sort of natural numbers with the successor relation s, and function symbols ƒ: [symbol] → [symbol] and F: ( [symbol] → [symbol] )→( [symbol] → [symbol] ), where F is required to be prefix-preserving, and writing φ as

$$∀ {t}_{0} , … {t}_{k} \cdot [ {{∧}_{l = 0}}^{k - 1} s ( {t}_{i} , {t}_{i + 1} ) ] \to ϕ ( f ( {t}_{0} ) , … , f ( {t}_{k} ) , F ( f ) ( {t}_{0} ) , … , F ( f ) ( {t}_{k} ) )$$

Fix a logic [symbol] and let [symbol] be the sort it operates over. First extend it with function symbols ƒᵢ: [symbol] → [symbol] and Fⱼ: ( [symbol] → [symbol] )→( [symbol] → [symbol] ), where F is required to be prefix-preserving. If ψ is any formula in this extended language, then

$$ϕ := ψ \vert ϕ ∧ ϕ \vert ¬ ϕ \vert ∀ {t}_{1} , … , {t}_{m} \cdot [ {∧}_{( i , j ) ∈ I} s ( {t}_{i} , {t}_{j} ) ] \to ϕ$$

defines a second extension to the language which we shall refer to as the guarded successor extention of [symbol] . The sublanguage of the form

$$ϕ := ψ \vert ϕ ∧ ϕ \vert ¬ ϕ \vert ∀ {t}_{1} , … , {t}_{m} \cdot [ {∧}_{( i , j ) ∈ I} s ( {t}_{i} , {t}_{j} ) ] \to ψ$$

will be called the collapsed fragment. Its sublanguage of the form

$$ϕ := {∨}_{k} ( ∀ {t}_{1} , … , {t}_{m} \cdot [ {∧}_{( i , j ) ∈ {I}_{k}} s ( {t}_{i} , {t}_{j} ) ] \to {ψ}_{k}^{1} ) ∧ ( ∃ {t}_{1} , … , {t}_{m} \cdot [ {∧}_{( i , j ) ∈ {J}_{k}} s ( {t}_{i} , {t}_{j} ) ] ∧ {ψ}_{k}^{2} )$$

will be called the normalized fragment. In all cases, the guard ∧_{(i,j)∈I}s(tᵢ, tⱼ) is required to uniquely determines the relative position between each tᵢ, tⱼ, and

$$ψ , {ψ}_{k}^{1} , {ψ}_{k}^{2}$$

involve t₁, . . . , tₘ only through application of ƒ, F (or several such functions), while ƒ, F may also be applied to constants from [symbol] .

Applying ƒ, F to constants from [symbol] corresponds to the above initial conditions.

Any formula in a guarded successor extension can be written as an equisatisfiable formula in the normalized fragment.

It is easy to see that we can always reduce into the collapsed fragment: this is immediate from the uniqueness of successor, for example ∀n∃k.s(n, k)∧ . . . is same as ∀nk.s(n, k)→ . . . . For the normalized form, first convert the formula to DNF at its outermost level, so each literal may be a complex quantified formula, then collapse the quantifier alternation as above, so each quantified formula is either universal or existential. Moving to NNF we can consider universal and existential literals instead of positive and negative literals. In each DNF clause we can collapse the universal parts into a single one since universals distribute over conjunctions. Given an existential literal ∃T.γ(T)∧φ while denoting T=t₁, . . . , tₖ, we introduce a flag e which is an additional output variable, and write

[∃t·e(t)=0]∧∀T·γ(T)→[e(k−1)=1∧(e(tₖ)=0↔(ψ∧e(tₖ−1)=0))]

where tₖ=max{t₁, . . . , tₖ} is assumed. The existential part is therefore reduced into a single atom at the expense of introducing a new output stream, and with introducing new universal literals which can then be collapsed into a single one as above. Given multiple single-atom existential parts ∧ₖ∃t·eₖ(t)=0 we can easily see that they are equivalent to ∃t.[∪ₖeₖ(t)]=0 because each flag remains zero once it becomes zero, so there is a point in time where all flags are eventually zero, so the existential part can be merely a single ∃n.e(n)=0 by defining this additional flag in the universal part. By that we reduced both the universal and the existential parts into a single one each.

Note that here we had to use the assumption that we are dealing with infinite time structures, namely N=∞. In the finite-time case we will also need the end-of-sequence predicate #, resulting with a slightly more complicated quantifier collapse. We omit this simple derivation here for sake of brevity.

Any formula in a guarded successor extension without temporal existential quantifiers can be written in a free-variable BL [k] form φ(Xₖ, Yₖ).

We of course bear in mind that if some language is decidable and is weakly ω-categorical, then its extension with recurrence relations is also decidable. Together with a method to handle the existential part as described in the next section, we'll conclude that:

Satisfiability of a formula in a guarded successor extension is decidable if this fragment is obtained from a decidable language [symbol] which is weakly ω-categorical, enhanced with the sort [symbol] , guarded successors, [symbol] → [symbol] function symbols, and BL[k] function symbols.

We refer to this extended language as GSSOTC[ [symbol] ], where GSSOTC stands for GuardedSuccessor Second-Order Time-Compatible. The second-order part is due to the following: given two sequences ƒ, g: [symbol] → [symbol] , we can declare a non-standard quantifier alternation ∀ƒ∃g, which would translate into ∃F∀ƒ (so far just standard higher-order skolemization), where F is a TC function between sequences. Those function quantifiers are eliminated when converting the formula to the free-variable form, which is then converted to function-free recurrence-relation form.

Some easy extensions of this language were described above, we reiterate them and add more: the end-of-string predicate #, having multiple successor relations and by that considering trees rather sequences, having constant positions, so instead of e.g. φ(xₙ, xₙ₋₁, yₙ), we have e.g. φ(x₁, x₂, xₙ, xₙ₋₁, yₙ), having explicit second-order quantifiers that are eliminated by reduction to recurrence relations, and finally, having richer quantifier alternation, e.g. for all keyboard input at time n, exists a memory state at time n, s.t. for all network input at time n, and so on, resulting in quantification of the form ∀x₁∃y₁∀z₁∀x₂∃y₂∀z₂∀x₃∃y₃ ∀z₃ . . . .

### Decision Methods and Execution

In the spirit of remark 24, we shall have several input and output sequences, each referred to as a stream.

Given

$$ϕ ( {X}_{j}^{i} , {Y}_{j}^{i} )$$

where X are inputs and Y are outputs, and i denoting the stream Given number, define the recurrence relation

$${ϕ}_{0} ( {X}_{k}^{i} , {Y}_{k}^{i} ) := ϕ ( {X}_{k}^{i} , {Y}_{k}^{i} )$$

$${ϕ}_{n} ( {X}_{k}^{i} , {Y}_{k}^{i} ) := ϕ ( {X}_{k}^{i} , {Y}_{k}^{i} ) ∧ ∀ {x}_{k + 1} ∃ {y}_{k + 1} \cdot {ϕ}_{n - 1} ( {X}_{k + 1}^{i} , {Y}_{k + 1}^{i} )$$

so φₙ means that exists a model with time points 0, . . . , n+k starting with

$${X}_{k}^{i} , {Y}_{k}^{i} .$$

Then the recurrence relation is monotonic, namely

$$∀ n ∀ {X}_{k}^{i} {Y}_{k}^{i} \cdot {ϕ}_{n + 1} ( {X}_{k}^{i} , {Y}_{k}^{i} ) \to {ϕ}_{n} ( {X}_{k}^{i} , {Y}_{k}^{i} )$$

and therefore has a fixed point. Denote it by

$${ϕ}_{∞} ( {X}_{k}^{i} , {Y}_{k}^{i} ) .$$

Given a model of φ with m time points, and given each input Xⁱ at point m+1, then an output Yⁱ will have an unbounded continuation satisfying φ if

$${ϕ}_{∞} ( {X}_{m + 1}^{i} , {Y}_{m + 1}^{i} ) .$$

A model of size n+1 exists if ∀x₀∃y₀ . . .

$$∀ {x}_{n} ∃ {y}_{n} \cdot {∧}_{m = k}^{n} ϕ ( {X}_{m}^{i} , {Y}_{m}^{i} ) .$$

Leaving free the first k+1 time points we can write

$$\begin{matrix}{ϕ}_{n - k} ( {X}_{k}^{i} , {Y}_{k}^{i} ) := ∀ {x}_{k + 1} ∃ {y}_{k + 1} ... ∀ {x}_{n} ∃ {y}_{n} \cdot {{∧}_{m = k}}^{n} ϕ ( {X}_{m}^{i} , {Y}_{m}^{i} ) \\ = ∀ {x}_{k + 1} ∃ {y}_{k + 1} ... ∀ {x}_{n} ∃ {y}_{n} \cdot ϕ ( {X}_{k}^{i} , {Y}_{k}^{i} ) ∧ {{∧}_{m = k + 1}}^{n} ϕ ( {X}_{m}^{i} , {Y}_{m}^{i} ) \\ = ϕ ( {X}_{k}^{i} , {Y}_{k}^{i} ) ∧ ∀ {x}_{k + 1} ∃ {y}_{k + 1} ... ∀ {x}_{n} ∃ {y}_{n} \cdot {{∧}_{m = k + 1}}^{n} ϕ ( {X}_{m}^{i} , {Y}_{m}^{i} ) \\ = ϕ ( {X}_{k}^{i} , {Y}_{k}^{i} ) ∧ ∀ {x}_{k + 1} ∃ {y}_{k + 1} \cdot {ϕ}_{n - k - 1} ( {X}_{k + 1}^{i} , {Y}_{k + 1}^{i} )\end{matrix}$$

since replacing k with k+1 in

$${ϕ}_{n - k} ( {X}_{k}^{i} , {Y}_{k}^{i} ) := ∀ {x}_{k + 1} ∃ {y}_{k + 1} ... ∀ {x}_{n} ∃ {y}_{n} \cdot {∧}_{m = k}^{n} ϕ ( {X}_{m}^{i} , {Y}_{m}^{i} )$$

results with

$${ϕ}_{n - k - 1} ( {X}_{k + 1}^{i} , {Y}_{k + 1}^{i} ) := ∀ {x}_{k + 2} ∃ {y}_{k + 2} ... ∀ {x}_{n} ∃ {y}_{n} \cdot {∧}_{m = k + 1}^{n} ϕ ( {X}_{m}^{i} , {Y}_{m}^{i} ) .$$

In case that

$$∀ {x}_{0} ∃ {y}_{0} ... ∀ {x}_{k} ∃ {y}_{k} \cdot {ϕ}_{∞} ( {X}_{k}^{i} , {Y}_{k}^{i} )$$

then due to monotonicity, every k+1 subsequence of time points will have to satisfy

$${ϕ}_{∞} ( {X}_{k}^{i} , {Y}_{k}^{i} ) ,$$

and any such subsequences can be extended arbitrarily due to the fact that it is a fixed point indeed.

The above formulation suggests that φ_{∞} is a normal form of φ when understood as defining TC models.

A TC structure is a model of φ if any subsequence satisfies φ_{∞} when understood as a formula in the language of BA.

Given inputs at each point of time, satisfying outputs can be computed by substituting the known variables into φ_{∞}, and solving for the missing outputs. This is an execution method for software specification in this language. Software specification in this language is therefore directly executable as-is, using an oracle to determine satisfying assignments to formulas in the language of atomless BA. Finding satisfying assignments to a formula in the language of atomless BA is a topic by its own, and is omitted here for sake of brevity.

Given two formula

$$ϕ ( {X}_{j}^{i} , {Y}_{j}^{i} ) , ψ ( {X}_{j}^{i} , {Y}_{j}^{i} ) ,$$

then the set or TC models of φ is a subset of those of ψ, if

$$∀ {x}_{0} {y}_{0} ... {x}_{k} {y}_{k} \cdot {ϕ}_{∞} ( {X}_{k}^{i} , {Y}_{k}^{i} ) \to {ψ}_{∞} ( {X}_{k}^{i} , {Y}_{k}^{i} ) .$$

This gives us an algorithm to decide whether φψ′=0 where φ, ψ are seen as sets of TC models.

Combined this with the above, this corollary gives us a decision procedure for the full language GS. Each DNF clause will have a single universal and a single existential (which is a negated universal), so deciding emptiness for each clause comes down to the last corollary.

Since φ_{∞} refers only to the universal parts, while the existential parts may of course restrict the models, therefore we should, at execution time, check at each point of time whether we can satisfy the existential parts. If so, we satisfy them indeed, just once. If the formula is satisfiable then such point in time is guaranteed to exist. If there are multiple existential parts in a DNF clause, then for execution, we have to squeeze them into one using the flags as in the proof of 35, since those existential parts may depend on each other.

When φ(xₙ, yₙ) is understood as a GS formula, and φ is in the language of atomless BA interpreted in this very BA of GS formulas (possibly with more algebras as the construction is closed under products), then NSO is a sublanguage of this language. That'd be a software specification language where inputs and outputs are nothing but sentences in this very language. This way we can support the software update mechanism described in the introduction as a crucial component for safe AI. Another way to look at it: a robot is programmed in a language [symbol] and accepts commands form the user in the very same language [symbol] . Now its internal program has to ask whether the command is consistent with, say, safety conditions. It couldn't do so unless [symbol] is a temporal logic with inputs in [symbol] equipped with the theory of BA.

### Complexity

Quantifier elimination in theories of BA where constants are either 0, 1 were studied by Tarski by introducing his so-called invariants. Kozen [3] extended this notion of invariants and by that derived a complexity characterization for the decision problem. For infinite BAs, it is complete for U_{c}STA (*, cⁿ, n). Roughly, this means anything that can be done in exponential time by an alternating Turing machine with linearly many alternations. For the two-element BA, it is simply QBF which is maybe the most famous PSPACE-complete problem. For GS, we saw that the number of formulas with fixed number of free variables and constants, is triple-exponential in the number of the free variables. This gives an upper bound for GS over atomless BA.

We have presented new methods in the theory of atomless BA that extend existing results from SBF to BF in general. We also presented the concept of weakly ω-categorical theories and how they relate to decidable recurrence relation extensions. We used those ideas to construct a language that can speak of its own sentences by abstracting them to merely BA elements. We further extended this construction to a novel temporal logic with several distinguishing abilities.

### 19—METHOD FOR ELIMINATING FUNCTION QUANTIFIERS

Now consider an algorithm taking a formula in GSSOTC [L] and using algorithms in L[RR] (the language L enhanced with recurrence relations and potentially additional extensions, as described above) to determine whether there exists some natural number N such that for all K≥N there is a sequence of length K satisfying the original formula. In particular, this will guarantee the existence of an infinite sequence (or functions between sequences, such as from inputs to outputs in a time compatible fashion). Such L[RR] algorithms can be used when the language L is weakly W-categorical.

A formula in GSSOTC[L] is a prefix of time-compatible function quantifiers, followed by a matrix. For simplicity (and without loss of generality), the matrix is assumed to be in disjunctive normal form (DNF). Its general form is therefore Q₁ƒ₁ . . . . Qₖƒₖ·∨ᵢ∧ⱼ [symbol] where each literal [symbol] is either of the form ∀t₁, . . . , tₙ·γᵢⱼ→φᵢⱼ or of the form ∃t₁, . . . , tₙ·γᵢⱼ∧φᵢⱼ. In addition, each Q is either “∀” or “∃”, each γᵢⱼ is a conjunction of atoms over s, # in a way that uniquely determines the relative positions as above, and φᵢⱼ is any formula in the language L. Each formula may depend on unary functions ƒ₁, . . . , ƒₖ applied to t₁ . . . , tₙ. Each function is therefore of type [symbol] → [symbol] . Note that the function quantifiers must appear as the outermost quantifiers. The universal case is treated here, and the existential case follows from the next section.

The method here decides satisfiability of Q₁ƒ₁ . . . Qₖƒₖ. ∨ᵢ∧ⱼlᵢⱼ by producing an equisatisfiable formula in L [RR]. The method produces a recurrence relation indexed by n that expresses “there exists a string of length n satisfying the formula” and has free variables denoting the first elements of the sequence (those are to be quantified later on in order to get a final answer). It is a recurrence relation because existence of string of length n can be expressed recursively from a formula expressing the existence of a string of length n−1, and this observation is the key. In the simplest case it may take the form φₙ(x):=∃y. φ(x, y)∧φₙ₋₁(y) among other possible forms. If L is weakly ω-categorical, then essentially by definition it is possible to obtain L[RR] formulas that are equivalent to L formulas.

When constant positions appear in a formula, such as s(5, n), the number of free variables in φₙ cannot be smaller than the largest constant, because those free variables denote the beginning of the sequence. Enforcing the conditions on the beginning of the sequence from the original formula is then achieved by joining the φₙ with those conditions and then quantifying the free variables. This should happen for each n in the looping sequence of formulas. In particular, because of the weakly ω-categorical assumption, there exist positive integers N and K for which φ_{N}=φ_{N+K} and therefore those initial conditions should be verified for φ_{N}, φ_{N+1}, . . . , φ_{N+K} separately.

Formulas may be interpreted as speaking about finite strings or about infinite strings. If the symbol # is not used, then an infinite string exists if there exists a finite string of any large enough length. This is straightforward to check given the method here. If the symbol # is used, then it is possible to check whether the formula requires that strings must be finite. Specifically, it is possible to check whether a formula entails the formula ∃n∀k.s(n, k)→⊥ because the methods here (including in the section below) can be used to determine logical consequence. Moreover, it is possible to join the original formula with the negation of the latter formula, enforcing infinite strings only.

### 20—BOOLEAN COMBINATION OF SETS OF MODELS

Given two formulas of the form ∃ƒ∀nk.s(n, k)→φ(ƒ(n), ƒ(k)) and ∃ƒ∀nk.s(n, k)→ψ(ƒ(n), ƒ(k)), their disjunction is simply

∃ƒ(∀nk·s(n,k)→φ(ƒ(n),ƒ(k))∨∀nk·s(n,k)→ψ(ƒ(n),ƒ(k)))

The disjunction is not ∃ƒ∀nk.s(n, k)→[φ(ƒ(n), ƒ(k))∨ψ(ƒ(n), ƒ(k))]. This latter formula expresses a condition of the form “the exists a string such that in any position, either φ holds or ψ holds.” However, sometimes it is useful to express a Boolean combination of sets of models (strings) like the former formula, and ask whether this Boolean combination is empty. Intersection happens to correspond to conjunction of formulas, but this is not the case for negation and disjunction.

Deciding whether a Boolean combination of sets of models (each expressed as a formula) is empty can be done as follows. Assume the formula is given in DNF. Then intersection of positive literals collapses into a single one (i.e., one expressed by a single formula). Determining emptiness of this DNF can be achieved by checking whether each single DNF clause is empty. It is therefore sufficient to decide emptiness of a combination of the form {

[symbol]

$${⋂}_{n = 1}^{N} {\{ {ψ}_{i} \}}^{C} ,$$

where {⋅} interprets a formula as a set of models. This too is done by conversion to L[RR]. Define

$${η}_{n}^{S}$$

for each S⊆{1, . . . , N} as a document mutation indexed by n, which expresses “there exists a string of length n such that φ holds in each position, and for all i, ψᵢ fails in some position if i∈S”. In some embodiments, the free variables in

$${η}_{n}^{S}$$

are the values at the initial positions (all in the above fashion), and possibly N more variables that are constrained. The potential additional variables must be either 0 or 1. The additional variables do not require

$${η}_{n}^{S}$$

only ηₙ, because those variables encode S. Emptiness is then decided by examining satisfiability of

$${η}_{n}^{\{ 1 , ... , N \}} .$$

In its simplest form and in case of unction symbols having one input and one output as well as lookback having a single input and single output, η looks like

$${η}_{n}^{S} ( x , y ) = ∀ {x}^{′} ∃ {y}^{′} \cdot ϕ ( x , y , {x}^{′} , {y}^{′} ) ∧ {⋁}_{A ∈ {2}^{S}} [ {η}_{n - 1}^{S \backslash A} ( {x}^{′} , {y}^{′} ) ∧ {⋀}_{i ∈ A} ¬ {ψ}_{i} ( x , y , {x}^{′} , {y}^{′} ) ]$$

where the ∧_{i∈A}¬ψᵢ(x, y, x′, y′) part says that the relevant ψ's fail at the initial position, and the part

$${η}_{n - 1}^{S ∖ A} ( {x}^{′} , {y}^{′} )$$

says that they fail in some other position.

### 21—REVISION AND FORCING

Consider the following example: a program gathers knowledge from a user (as inputs), and adds it to some internal knowledgebase. Sometimes the user might input a piece of knowledge that is inconsistent with previous knowledge. But in GSSOTC, the lookback is bounded, so there's no way to express looking back at all past inputs and make a decision based on them. A remedy for this is introduced by extending the language with what may be called a “forcing operator”.

First, consider a program that adds knowledge to a knowledgebase:

φ(xₙ₋₁,xₙ,yₙ):=(xₙ=(xₙ₋₁∧yₙ))

where xₙ is the current knowledgebase, xₙ₋₁ is the previous knowledgebase, and yₙ is the current input. The goal is to force the knowledgebase to always be consistent, which can be written as:

φ(xₙ₋₁,xₙ,yₙ):=(xₙ=(xₙ₋₁∧yₙ)∧F(xₙ≠0)

using a forcing operator F. This means that at execution time, an extra-logical engine will be invoked (when necessary to satisfy the forcing condition) to perform some arbitrary operation (e.g., displaying to the user all previous inputs and ask the user to edit them so that the condition xₙ≠0 is satisfied). In the consistency check of this GSSOTC formula, it is assumed that xₙ≠0, relying on the extra-logical operation (whatever it may be) to force this condition to hold.

In a more general sense, a formula containing the forcing operator F such as

φ(xₙ₋₁,xₙ,yₙ)=ψ(xₙ₋₁,xₙ,yₙ)∧F(χ(xₙ₋₁,xₙ,yₙ))

is checked for consistency by reducing it to checking consistency of

∀yₙ∃xₙ·χ(xₙ₋₁,xₙ,yₙ)→ψ(xₙ₋₁,xₙ,yₙ)

∃yₙ∃xₙ·ψ(xₙ₋₁,xₙ,yₙ)∧χ(xₙ₋₁,xₙ,yₙ)

### 22—EMBEDDED EXECUTION

In combination with the teaching of NSO above, GSSOTC may take as inputs and outputs sentences in GSSOTC itself. Sometimes it is useful to take a GSSOTC program as an input and execute it. This can be expressed in the form φ(xₙ):=E(xₙ), which means “execute the input xₙ.” However execution itself is clearly not expressible in GSSOTC and needs to be an extra-logical operation. Therefore, assume that E returns either 0 or 1, depending on whether the execution was successful. Note that xₙ might look back at the states already computed by φ, so consistency is relative to the history of the higher-level program φ, its inputs, and states. The consistency check is now straight forward: simply rewrite the formula such that the return value of E is either 0 or 1, and check for consistency as usual. An extra-logical engine performs the execution and returns 0 or 1.

### 23—EXAMPLE OF A SOFTWARE SPECIFICATION LANGUAGE

Consider the example given in the NSO discussion above (sections 11-13). It involves conditions of accepting a software update. However, the language in that case not only needs to support checks for updates, but also needs to be rich enough to serve a software specification language. A key point about being a software specification language is to be a so-called “temporal logic,” being able to express things of the form “first do this, then do that.” Further, inputs and outputs should be considered and distinguished from each other (which is not supported in many temporal logics). The temporal logic here allows describing processes (e.g. software) with inputs and outputs, and further verifying that for each input there exists a [time-compatible] output. Moreover, the temporal logic also supports a specification language that can deal with its own sentences because the temporal logic can easily be considered as an atomless Boolean algebra. Using the techniques in the NSO example allow checkable updates in a language rich enough to express software.

### 24—THE TAU 1.0 LANGUAGE

### Overview

We are now ready to define a language that contains all the extensions in this monograph, which is the Tau language. There is no one Tau language: it depends on which base logics we extend. It therefore consists of the following:
(1) Take GSSOTC over the BAs being:
   (a) The base logics,
   (b) Tau formulas themselves (with models being time-compatible functions between sequences),
   (c) NSO formulas over the base logics,
   (d) The above logics with one free variable s.t. their quantifier is simple,
   (e) All BFs, SBFs, and their higher order counterparts, in those BAs.
(2) In both the GSSOTC level and the NSO level, support:
   (a) Cartesian product,
   (b) Relations with converse,
   (c) Simple quantifiers,
   (d) Infinitely many homomorphism and hemimorphism symbols in the signature,
   (e) Infinitary operations as described,
   (f) Recurrence relations,
   (g) Infinitely many uninterpreted constant symbols, in order to allow defining “terminology”.
(3) The most important base BAs are:
   (a) All finite BAs, encoded as integers wrt bitwise operations, and with addition implemented logically,
   (b) All finite BAs of order 22n encoded as SBFs of finitely many variables, while syntactically supporting substitution and composition,
   (c) Their higher-order counterparts,
   (d) The countable atomless BA SBF.

### Tables

The basic idea is to support functions 2ⁿ→B where B is any BA supported in the Tau language (including products algebra of algebras thereof). This encodes a set of tuples (in the case of product, or 1-tuple if no product is used) where each tuple has an n-bit identifier (possibly taken from prefix codes). Since in this formulation all keys have a value, we set the default value to be zero. It is easy to see how to directly implement this in the Tau language, however we're interested in fixing some syntactic sugar that'll give rise to implementation optimizations. The first kind of atomic formula is of the form

T₁=set(T₂,k,v)

which means that table T₁ is simply the table T₂ where the value in key k is set to v, overriding any previous value. It is a conservative extension because it can be expressed as

$${T}_{1} ( {k}_{1} , ... , {k}_{n} ) = v ∧$$

$$∀ {x}_{1} , ... {x}_{n} \cdot [ {⋀}_{i} ( {x}_{i} = 0 ∨ {x}_{i} = 1 ) ∧ {x}_{i} \neq {k}_{i} ] \to {T}_{1} ( {x}_{1} , ... , {x}_{n} ) = {T}_{2} ( {x}_{1} , ... , {x}_{n} )$$

where T₁, T₂ are of type BF.

An even more succinct representation is where the table is of the form 2²^{ⁿ}→B so the key k: SBF[n] is an SBF with n variables. The above atomic formula could then be expressed as

T₁(k)=v∧∀x·x+k→T₁(x)=T₂(x)

For another kind of atomic formula:

T₁=select(T₂,φ(v))

which means that T₁ contains all values v in T₂ that satisfy the formula φ(v). This is again easily expressed as

∀k∀v·(v=T₂(k))→(φ(v)?T₁(k)=v:T₁(k)=0)

Another atomic formula would be

$$u = {⋂}_{v \vert ϕ ( v )} T$$

which is an abuse of notation, and intended to mean: take all values v in T that satisfy φ(v) and equate their conjunction in u. To this end, we first use select, and then we're left with computing u=∩ᵥT which can be expressed as

$$u = {⋂}_{k ∈ {2}^{n}} T ( k )$$

however to avoid a formula of exponential length we can write a recurrence relation

ƒₙ(T)=ƒₙ₋₁(T|ₖ_{ₙ}=0)∩ƒₙ₋₁(T|ₖ_{ₙ}=1)

and if the implementation allows the user to specify that certain recurrence relations will be unfolded only during runtime, it is easy to see that in many cases, the execution of that recurrence relation will not take exponential time. Clearly recurrence relations will have to be extended to also iterate over a fixed span of argument identifier.

Next we move to intersection and symmetric difference of tables seen as set of tuples. For intersection:

T₁=common(T₂,T₃)

we can express as

∀k∀v·(T₁(k)=v∧T₂(k)=v)?T₁(k)=v:T₁(k)=0

and similarly for symmetric difference. Next we move to pointwise Boolean operations in tables. This is readily implemented by simple T₁=T₂∩T₃ etc. There isn't even a need for quantification over keys as this coincides with the usual Boolean operations over BFs.

For internal optimization, we convert the formula to implicational form where those new atomic formulas are the only ones in the implicants. This can be done in CNF and BDD forms. When the condition is triggered, an internal table modification is performed.

### Pointwise Revision

Given a Tau specification (spec), we can execute a candidate program that meets this spec. Suppose we′d like to support a “software update” feature. Another use case of this scenario is a robot that accepts commands from the user, while those commands are nothing but change of spec, and while the robot itself is programmed in Tau. To support this we add an extralogical operation of update: whenever a certain output stream is assigned a Tau BA element which is nonzero, it automatically becomes the new spec, and the execution backend stops executing the current spec and continues to run the new spec (the “update”).

However each spec may have many programs that satisfy it. How to choose one program? We combine an answer to this question with an answer to another problem: suppose the update (or the robot's command) is only intended to be some change or addition, and we don't want the user to specify the whole program or robot behaviour from scratch with each update. Mitigating such situation is done by what we'll refer to as pointwise revision. Given two Tau formulas φ(xₙ, yₙ) and ψ(xₙ, yₙ), where x is an input stream and y is an output stream (and no lookback but that's w log and for simplicity of presentation), define

χ=φ*ψ

by

χ(xₙ,yₙ):=ψ(xₙ,yₙ)∧[(∃t·φ(xₙ,t)∧ψ(xₙ,t))→φ(xₙ,yₙ)]

this reads as follows: at each point of time n, there may be many possible outputs yₙ that satisfy the spec. We choose an output that always satisfies w, but we prefer the outputs that also satisfy φ. This implies that the new spec will take as much as possible from the behavior of the old spec, as long as the new spec is satisfied, and indeed this preservation is easily seen to be maximal.

One more enhancement of the above setting is in place. Instead of assigning to an output stream the new spec, we assign to it a formula with a dedicated uninterpreted constant typed as an element of the Tau BA. Then all possible interpretations of this constant are admissible updates. To perform pointwise revision we need to choose one interpretation. We have the freedom to choose either a [close to] maximal or a [close to] minimal solution (cf. e.g. lemma 3.4). The former will preserve as much as possible from the previous spec, while the latter the least possible.

A broad extension of this idea is as follows. It might be that y is unsatisfiable in the sense that it is not the case that for any input exists a time-compatible output. However it might be that for some inputs exist outputs indeed, in which case we′d prefer them over outputs of φ, but otherwise we can use φ. The extended operator is therefore

$$χ ( {x}_{n} , {y}_{n} ) := \begin{matrix}( ∃ t \cdot ψ ( {x}_{n} , t ) ) \to ψ ( {x}_{n} , {y}_{n} ) \\ ⋀ ( ¬ ∃ t \cdot ψ ( {x}_{n} , t ) ) \to ϕ ( {x}_{n} , {y}_{n} ) \\ ⋀ ( ∃ t \cdot ϕ ( {x}_{n} , t ) ∧ ψ ( {x}_{n} , t ) ) \to ϕ ( {x}_{n} , {y}_{n} )\end{matrix}$$

### EXAMPLE EMBODIMENTS

(A1) In some embodiments, a method is performed at a computing device having one or more processors and memory. The memory stores computer instructions configured for execution by the one or more processors. The method includes: (i) receiving user input to specify software requirements for a program, the software requirements expressed as a sentence φ in a temporal formal language with guarded successors GSSOTC(L), wherein the sentence φ includes temporal input variables; (ii) determining whether for each temporal input yₙ there is a corresponding output xₙ satisfying φ(xₙ₋₁, xₙ, yₙ), wherein xₙ₋₁ is an output from a prior point in time; and (iii) in accordance with a determination that for each input yₙ there is a corresponding output xₙ satisfying φ(xₙ₋₁, xₙ, yₙ), executing an instance of a program that satisfies the software requirements.

(A2) In some embodiments of (A1), L is a base formal language, and GSSOTC(L) is an extension of L with guarded successors.

(A3) In some embodiments of (A1) or (A2), each input yₙ is a sentence in the formal language GSSOTC(L).

(A4) In some embodiments of any of (A1)-(A3), one or more input yₙ is a sentence in the base language L.

(A5) In some embodiments of any of (A1)-(A4), each output xₙ is a sentence in the formal language GSSOTC(L).

(A6) In some embodiments of any of (A1)-(A5), one or more output xₙ is a sentence in the base language L.

(A7) In some embodiments of any of (A1)-(A6), executing the instance of the program includes receiving inputs y₁, y₂, . . . , yₘ from a user for some positive integer m.

(A8) In some embodiments of any of (A1)-(A7), executing the instance of the program includes displaying data on a display screen of the computing device, storing output data in the memory of the computing device, or transmitting output data to a remote device utilizing a network interface of the computing device.

(A9) In some embodiments of any of (A1)-(A8), each sentence in GSSOTC(L) comprises a prefix of time-compatible function quantifiers followed by a formal language matrix consisting of a quantifier-free formula.

(A10) In some embodiments of (A9), the method further comprises translating the sentence φ into an equivalent sentence φ′ in GSSOTC(L) that is in disjunctive normal form.

(A11) In some embodiments of (A10), the equivalent sentence φ′ is of the form Q₁ƒ₁ . . . Qₖƒₖ∨ᵢ∧ⱼlᵢⱼ, each function quantifier Q₁, . . . , Qₖ is “∃” or “∀”, each function ƒ₁, . . . , ƒₖ is a unary function whose domain is a contiguous set of positive integers specifying position, and each literal lᵢⱼ is of the form ∀t₁, . . . , tₙ·γᵢⱼ→φᵢⱼ or ∃t₁, . . . , tₙ·γᵢⱼ∧φᵢⱼ.

(A12) In some embodiments of (A11), each formula γᵢⱼ is a conjunction of positive atomic formulas utilizing a successor predicate s( ) and/or a last position predicate #( ) the successor predicate s( ) is defined by s(a,b) if a=b+1 and the last position predicate #( ) is defined by #(a) if a is at a final position in sequence.

(A13) In some embodiments of (A12), for each formula γᵢⱼ, the successor predicate s( ) utilized in the formula γᵢⱼ uniquely determine relative positions of the position indicators t₁ . . . , tₙ.

(A14) In some embodiments of (A11), each formula φᵢⱼ is a formula, in the formal language L, that may depend on the unary functions ƒ₁, . . . , ƒₖ as applied to position identifiers t₁, . . . , tₙ.

(A15) In some embodiments of any of (A1)-(A14), determining whether for each temporal input yₙ there is a corresponding output xₙ satisfying φ(xₙ₋₁, xₙ, yₙ) comprises:
for the sentence φ, constructing an equisatisfiable formula φ″ in L[RR] consisting of recurrence relations in the formal language L; and
determining satisfiability of the equisatisfiable formula φ″.

(A16) In some embodiments of (A15), determining satisfiability of the equisatisfiable formula φ″ comprises unfolding the recurrence relations in the equisatisfiable formula φ″.

(A17) In some embodiments of (A16), unfolding the recurrence relations includes identifying a fixed point.

(A18) In some embodiments of any of (A1)-(A17), determining whether for each temporal input yₙ there is a corresponding output xₙ satisfying φ(xₙ₋₁, xₙ, yₙ) comprises:
for the sentence φ, constructing a set of recurrence relations in L[RR]; and
determining satisfiability of the sentence φ according to the set of recurrence relations.

(A19) In some embodiments of any of (A1)-(A18), the sentence φ includes a forcing function F applied to a condition χ(xₙ₋₁, xₙ, yₙ), and F executes an extra-logical operation on the computing device to guarantee that the condition χ(xₙ₋₁, xₙ, yₙ) holds.

(B1) In some embodiments, a method of validating software updates is performed by a software system installed on a computing device having one or more processors and memory storing one or more programs configured for execution by the one or more processors. The method comprises: (i) receiving a candidate software update for the software system, wherein both the software system and the candidate software update are expressed in an extended formal language that is an extension of one or more base formal languages, wherein sentences in each base formal language, up to logical equivalence, form elements in a Boolean Algebra, that has a falsity element 0 denoting falsity and that has a truth element 1 denoting truth, wherein the extended formal language includes the first-order theory of Boolean Algebras interpreted in the Boolean Algebra arising from each base formal language, extended to include a plurality of constant symbols each corresponding to a respective logical equivalence class of sentences in each base formal language, wherein the extended formal language and each base formal language, regarded as Boolean Algebras under logical equivalence, are elementarily equivalent under a signature of Boolean Algebra, wherein the candidate software update corresponds to an update sentence u in the extended formal language; (ii) for a condition element c, in the extended formal language, specifying a condition to validate the candidate software update, computing a truth value for uc′=0 in the extended formal language, wherein uc′ is the logical conjunction of u with the logical negation of c; (iii) in accordance with a determination that uc′=0 is false, rejecting the candidate software update; and (iv) in accordance with a determination that uc′=0 is true, accepting the candidate software update, and installing the candidate software update on the computing device.

(B2) In some embodiments of (B1), the Boolean Algebra of each base formal language is atomless.

(B3) In some embodiments of (B1) or (B2), the Boolean Algebras of the extended formal language and each base formal language are isomorphic.

(B4) In some embodiments of any of (B1)-(B3), the condition c is a combination of different individual conditions each requiring to be satisfied for the candidate software update to be validated and accepted.

(B5) In some embodiments of any of (B1)-(B4), the candidate software update includes an update to the condition element c.

(B6) In some embodiments of (B5), if the candidate software update is accepted then the step of installing the candidate software update on the computing device comprises replacing the condition element c with an updated condition element d, in the extended formal language, specifying an updated condition to validate a subsequent candidate software update.

(B7) In some embodiments of (B6), the method further comprises: (i) receiving the subsequent candidate software update for the software system, wherein the subsequent candidate software update is expressed in the extended formal language; (ii) computing a truth value for ud′=0 in the extended formal language, wherein ud′ is the logical conjunction of u with the logical negation of d; (iii) in accordance with a determination that ud′=0 is false, rejecting the subsequent candidate software update; and (iv) in accordance with a determination that ud′=0 is true, accepting the subsequent candidate software update, and installing the subsequent candidate software update on the computing device.

(B8) In some embodiments, a non-transitory, computer-readable storage medium stores instructions thereon that, when executed by one or more of the processors of the computing device, cause the one or more processors to execute the method of any of (B1)-(B7).

(C1) In some embodiments, a software system validates software updates to the software system, the software system being installed on a computing device having one or more processors and memory storing one or more programs configured for execution by the one or more processors. The software system is configured to: (i) receive a candidate software update for the software system, wherein both the software system and the candidate software update are expressed in an extended formal language that is an extension of one or more base formal languages, wherein sentences in each base formal language, up to logical equivalence, form elements in a Boolean Algebra, that has a falsity element 0 denoting falsity and that has a truth element 1 denoting truth, wherein the extended formal language includes the first-order theory of Boolean Algebras interpreted in the Boolean Algebra arising from each base formal language, extended to include a plurality of constant symbols each corresponding to a respective logical equivalence class of sentences in each base formal language, wherein the extended formal language and each base formal language, regarded as Boolean Algebras under logical equivalence, are elementarily equivalent under a signature of Boolean Algebra, wherein the candidate software update corresponds to an update sentence u in the extended formal language; (ii) for a condition element c, in the extended formal language, specifying a condition to validate the candidate software update, compute a truth value for uc′=0 in the extended formal language, wherein uc′ is the logical conjunction of u with the logical negation of c; (iii) in accordance with a determination that uc′=0 is false, reject the candidate software update; and (i) in accordance with a determination that uc′=0 is true, accept the candidate software update, and install the candidate software update on the computing device.

(D1) In some embodiments, a method validates knowledge systems. The method is performed at a computing device having one or more processors and memory storing one or more programs configured for execution by the one or more processors. The method comprises: (i) storing a plurality of interrelated facts, represented by respective knowledge sentences, in a knowledge system, wherein the knowledge sentences are expressed in an extended formal language that is an extension of one or more base formal languages, wherein sentences in each base formal language, up to logical equivalence, form elements in a Boolean Algebra, that has a falsity element 0 denoting falsity and that has a truth element 1 denoting truth, wherein the extended formal language includes the first-order theory of Boolean Algebras interpreted in the Boolean Algebra arising from each base formal language, extended to include a plurality of constant symbols each corresponding to a respective logical equivalence class of sentences in each base formal language, wherein the extended formal language and each base formal language, regarded as Boolean Algebras under logical equivalence, are elementarily equivalent under a signature of Boolean Algebra; (ii) for each of a plurality of pairs of elements in the extended formal language, wherein each pair comprises a first element x representing a respective first knowledge sentence representing a first fact of the plurality of interrelated facts in the knowledge system and a second element y representing a respective second knowledge sentence representing a respective second fact of the plurality of interrelated facts in the knowledge system, evaluating the expression xy=0, wherein xy is the logical conjunction of x with y; and (iii) in accordance with a determination that there exists a pair of elements satisfying xy=0, determining that the knowledge system has stored facts that are inconsistent.

(E1) In some embodiments, a method of validating contract provisions is performed at a computing device having one or more processors and memory storing one or more programs configured for execution by the one or more processors. The method comprises: (i) receiving a contract, specified as a plurality of clauses represented by respective clause sentences, wherein the clause sentences are expressed in an extended formal language that is an extension of one or more base formal languages, wherein sentences in each base formal language, up to logical equivalence, form elements in a Boolean Algebra, that has a falsity element 0 denoting falsity and that has a truth element 1 denoting truth, wherein the extended formal language includes the first-order theory of Boolean Algebras interpreted in the Boolean Algebra arising from each base formal language, extended to include a plurality of constant symbols each corresponding to a respective logical equivalence class of sentences in each base formal language, wherein the extended formal language and each base formal language, regarded as Boolean Algebras under logical equivalence, are elementarily equivalent under a signature of Boolean Algebra; (ii) for each of a plurality of pairs of elements in the extended formal language, wherein each pair comprises a first element x representing a respective first clause sentence representing a first clause of the plurality of clauses in the contract and a second element y representing a respective second clause sentence representing a respective second clause of the plurality of clauses in the contract, evaluating the expression xy=0, wherein xy is the logical conjunction of x with y; and (iii) in accordance with a determination that there exists a pair of elements satisfying xy=0, determining that the contract has inconsistent provisions.

Many modifications may be made to the described examples without departing from the scope of the appended claims.

The terminology used in the description of the invention herein is for the purpose of describing particular implementations only and is not intended to be limiting of the invention. As used in the description of the invention and the appended claims, the singular forms “a,” “an,” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “comprises” and/or “comprising,” when used in this specification, specify the presence of stated features, steps, operations, elements, and/or components, but do not preclude the presence or addition of one or more other features, steps, operations, elements, components, and/or groups thereof.

The foregoing description, for purpose of explanation, has been described with reference to specific implementations. However, the illustrative discussions above are not intended to be exhaustive or to limit the invention to the precise forms disclosed. Many modifications and variations are possible in view of the above teachings. The implementations were chosen and described in order to best explain the principles of the invention and its practical applications, to thereby enable others skilled in the art to best utilize the invention and various implementations with various modifications as are suited to the particular use contemplated.

What is claimed is:

1. A method of symbolic artificial intelligence, performed at a computing device having one or more processors and memory storing one or more programs configured for execution by the one or more processors, the method comprising:
identifying an atomless Boolean Algebra B and a first-order language (logic) of Boolean Algebras, the language having constant symbols 0, 1, and extended with a plurality of additional constant symbols, each constant symbol uniquely interpreted as a respective element of B;
accessing an expression written in the extended first-order language, wherein the expression has one or more logical quantifiers;
selecting an innermost quantifier having a quantified variable x, and converting the expression, if necessary, so that the innermost quantifier is an existential quantifier;
identifying a subexpression f, of the expression, to which the innermost quantifier applies;
viewing the subexpression f as in disjunctive normal form having one or more DNF clauses cᵢ, each DNF clause comprising a conjunction of one or more literals, each literal is either (a) a positive literal pᵢⱼ(x)=0 or (b) a negative literal nᵢⱼ(x)≠0;
for each DNF clause cᵢ:
forming a single substitute positive literal pᵢ(x)=0 by either (a) combining all positive literals pᵢⱼ(x)=0 for the respective DNF clause into a single positive literal ∪ⱼpᵢⱼ(x)=0 when there is at least one positive literal or (b) specifying the single substitute positive literal as 0=0 when there is not at least one positive literal;
constructing a respective output clause of the form:
$${p}_{i} ( 0 ) {p}_{i} ( 1 ) = 0 ∧ {⋀}_{j} ( {p}_{i}^{′} ( 0 ) {n}_{ij} ( 0 ) ⋃ {p}_{i}^{′} ( 1 ) {n}_{ij} ( 1 ) \neq 0 )$$
$$or$$
$${p}_{i} ( 0 ) {p}_{i} ( 1 ) = 0 ∧ {⋀}_{j} ( {n}_{ij} ( {p}_{i} ( 0 ) ) ⋃ {n}_{ij} ( {[ {p}_{i} ( 1 ) ]}^{′} ) ) \neq 0$$
$$or$$
$${p}_{i} ( 0 ) {p}_{i} ( 1 ) = 0 ∧ {⋀}_{j} ( {n}_{ij} ( 0 ) {n}_{ij} ( 1 ) = 0 \to {[ {p}_{i} ( 0 ) ]}^{′} {n}_{ij} ( 0 ) + {[ {p}_{i} ( 1 ) ]}^{′} {n}_{ij} ( 1 ) \neq 0 ) ;$$
constructing a modified expression by replacing the innermost quantifier and the subexpression f with a disjunction of the DNF output clauses, thereby eliminating the innermost quantifier; and
providing an output on the computing device that shows the modified expression with fewer quantifiers than the expression.

2. The method of claim 1, wherein:
when the modified expression contains one or more quantifiers, repeating the selecting, identifying, viewing, forming and constructing for each DNF clause, and constructing until the modified expression has no more remaining quantifiers, resulting in a final modified expression with no quantifiers; and
providing the output on the computing device comprises showing the final modified expression with no quantifiers.

3. The method of claim 2, wherein the final modified expression is logically equivalent to the expression.

4. The method of claim 2, further comprising computing a truth value of the final modified expression and displaying the truth value of the final modified expression on a display of the computing device.

5. The method of claim 1, wherein the method comprises displaying data on a display screen of the computing device, storing output data in the memory of the computing device, and/or transmitting output data to a remote device utilizing a network interface of the computing device.

6. The method of claim 1, wherein the plurality of additional constant symbols comprises infinitely many symbols.

7. The method of claim 1, further comprising identifying a method of determining whether a Boolean combination of elements of B, corresponding to constant symbols of the language, results in 0.

8. The method of claim 1, wherein each of the one or more logical quantifiers is an existential quantifier or a universal quantifier.

9. The method of claim 8, including converting the expression when the selected innermost quantifier is a universal quantifier.

10. The method of claim 1, wherein each positive literal pᵢⱼ(x)=0 and each negative literal nᵢⱼ(x)≠0 comprises a first portion pᵢⱼ(x) or nᵢⱼ(x) that is a respective Boolean combination of (a) variables, (b) the constant symbols 0 and 1, and (c) the plurality of additional constant symbols.

11. The method of claim 1, wherein the disjunctive normal form for the subexpression f is:
$${⋁}_{i} ( {⋀}_{j} [ {p}_{ij} ( x ) = 0 ] ∧ [ {n}_{ij} ( x ) \neq 0 ] ) .$$

12. A computing device having one or more processors and memory storing one or more programs configured for execution by the one or more processors, the one or more programs comprising instructions for:
identifying an atomless Boolean Algebra B and a first-order language (logic) of Boolean Algebras, the language having constant symbols 0, 1, and extended with a plurality of additional constant symbols, each constant symbol uniquely interpreted as a respective element of B;
accessing an expression written in the extended first-order language, wherein the expression has one or more logical quantifiers;
selecting an innermost quantifier having a quantified variable x, and converting the expression, if necessary, so that the innermost quantifier is an existential quantifier;
identifying a subexpression f, of the expression, to which the innermost quantifier applies;
viewing the subexpression f as in disjunctive normal form having one or more DNF clauses cᵢ, each DNF clause comprising a conjunction of one or more literals, each literal is either (a) a positive literal pᵢⱼ(x)=0 or (b) a negative literal nᵢⱼ(x)≠0;
for each DNF clause cᵢ:
forming a single substitute positive literal pᵢ(x)=0 by either (a) combining all positive literals pᵢⱼ(x)=0 for the respective DNF clause into a single positive literal ∪ⱼpᵢⱼ(x)=0 when there is at least one positive literal or (b) specifying the single substitute positive literal as 0=0 when there is not at least one positive literal;
constructing a respective output clause of the form:
$${p}_{i} ( 0 ) {p}_{i} ( 1 ) = 0 ∧ {⋀}_{j} ( {p}_{i}^{′} ( 0 ) {n}_{ij} ( 0 ) ⋃ {p}_{i}^{′} ( 1 ) {n}_{ij} ( 1 ) \neq 0 )$$
$$or$$
$${p}_{i} ( 0 ) {p}_{i} ( 1 ) = 0 ∧ {⋀}_{j} ( {n}_{ij} ( {p}_{i} ( 0 ) ) ⋃ {n}_{ij} ( {[ {p}_{i} ( 1 ) ]}^{′} ) ) \neq 0$$
$$or$$
$${p}_{i} ( 0 ) {p}_{i} ( 1 ) = 0 ∧ {⋀}_{j} ( {n}_{ij} ( 0 ) {n}_{ij} ( 1 ) = 0 \to {[ {p}_{i} ( 0 ) ]}^{′} {n}_{ij} ( 0 ) + {[ {p}_{i} ( 1 ) ]}^{′} {n}_{ij} ( 1 ) \neq 0 ) ;$$
constructing a modified expression by replacing the innermost quantifier and the subexpression f with a disjunction of the DNF output clauses, thereby eliminating the innermost quantifier; and
providing an output on the computing device that shows the modified expression with fewer quantifiers than the expression.

13. The computing device of claim 12, wherein:
when the modified expression contains one or more quantifiers, repeating the selecting, identifying, viewing, forming and constructing for each DNF clause, and constructing until the modified expression has no more remaining quantifiers, resulting in a final modified expression with no quantifiers; and
providing the output on the computing device comprises showing the final modified expression with no quantifiers.

14. The computing device of claim 13, wherein the final modified expression is logically equivalent to the expression.

15. The computing device of claim 13, wherein the one or more programs further comprise instructions for computing a truth value of the final modified expression and displaying the truth value of the final modified expression on a display of the computing device.

16. The computing device of claim 12, wherein the one or more programs further comprise instructions for displaying data on a display screen of the computing device, storing output data in the memory of the computing device, and/or transmitting output data to a remote device utilizing a network interface of the computing device.

17. The computing device of claim 12, wherein each of the one or more logical quantifiers is an existential quantifier or a universal quantifier and the one or more programs comprise instructions for converting the expression when the selected innermost quantifier is a universal quantifier.

18. The computing device of claim 12, wherein each positive literal pᵢⱼ(x)=0 and each negative literal nᵢⱼ(x)=0 comprises a first portion pᵢⱼ(x) or nᵢⱼ(x) that is a respective Boolean combination of (a) variables, (b) the constant symbols 0 and 1, and (c) the plurality of additional constant symbols.

19. The computing device of claim 12, wherein the disjunctive normal form for the subexpression f is:
$${⋁}_{i} ( {⋀}_{j} [ {p}_{ij} ( x ) = 0 ] ∧ [ {n}_{ij} ( x ) \neq 0 ] ) .$$

20. A method of symbolic artificial intelligence, performed at a computing device having one or more processors and memory storing one or more programs configured for execution by the one or more processors, the method comprising:
identifying an atomless Boolean Algebra B and a first-order language (logic) of Boolean Algebras, the language having constant symbols 0, 1, and extended with a plurality of additional constant symbols, each constant symbol uniquely interpreted as a respective element of B;
accessing an expression written in the extended first-order language, wherein the expression has one or more logical quantifiers;
selecting an innermost quantifier having a quantified variable x, and, when the innermost quantifier is not an existential quantifier, converting the expression so that the innermost quantifier is an existential quantifier;
identifying a subexpression f, of the expression, to which the innermost quantifier applies;
viewing the subexpression f as in disjunctive normal form having one or more DNF clauses cᵢ, each DNF clause comprising a conjunction of one or more literals, each literal is either (a) a positive literal pᵢⱼ(x)=0 or (b) a negative literal nᵢⱼ(x)=0;
for each DNF clause cᵢ:
forming a single substitute positive literal pᵢ(x)=0 by either (a) combining all positive literals pᵢⱼ(x)=0 for the respective DNF clause into a single positive literal ∪ⱼpᵢⱼ (x)=0 when there is at least one positive literal or (b) specifying the single substitute positive literal as 0=0 when there is not at least one positive literal;
constructing a respective output clause of the form:
$${p}_{i} ( 0 ) {p}_{i} ( 1 ) = 0 ∧ {⋀}_{j} ( {p}_{i}^{′} ( 0 ) {n}_{ij} ( 0 ) ⋃ {p}_{i}^{′} ( 1 ) {n}_{ij} ( 1 ) \neq 0 )$$
$$or$$
$${p}_{i} ( 0 ) {p}_{i} ( 1 ) = 0 ∧ {⋀}_{j} ( {n}_{ij} ( {p}_{i} ( 0 ) ) ⋃ {n}_{ij} ( {[ {p}_{i} ( 1 ) ]}^{′} ) ) \neq 0$$
$$or$$
$${p}_{i} ( 0 ) {p}_{i} ( 1 ) = 0 ∧ {⋀}_{j} ( {n}_{ij} ( 0 ) {n}_{ij} ( 1 ) = 0 \to {[ {p}_{i} ( 0 ) ]}^{′} {n}_{ij} ( 0 ) + {[ {p}_{i} ( 1 ) ]}^{′} {n}_{ij} ( 1 ) \neq 0 ) ;$$
constructing a modified expression by replacing the innermost quantifier and the subexpression f with a disjunction of the DNF output clauses, thereby eliminating the innermost quantifier; and
computing a truth value t for the modified expression and, when t is true, performing a command corresponding to the expression, wherein performing the command comprises providing an output on the computing device, performing a calculation, initiating a workflow, and/or modifying a validation rule for the computing device.
